(19) United States
(12) Patent Application Publication
(10) Pub. No.: US 2015/0190743 A1
(43) Pub. Date: Jul. 9, 2015

(54) POINT-OF-USE WATER TREATMENT SYSTEM

(71) Applicant: Access Business Group International LLC, Ada, MI (US)

(72) Inventors: Terry L. Lautzenheiser, Nunica, MI (US); Michael E. Miles, Grand Rapids, MI (US); Karlis Vecziedins, Caledonia, MI (US); Kenneth E. Conrad, Ada, MI (US)

(21) Appl. No.: 14/663,997

(22) Filed: Mar. 20, 2015

Related U.S. Application Data
(63) Continuation of application No. 13/144,093, filed on Dec. 8, 2011.
(60) Provisional application No. 61/143,934, filed on Jan. 12, 2009.

(51) Int. Cl. B01D 36/00; C02F 1/00; B01D 35/147; C02F 1/32

(52) U.S. Cl. CPC B01D 36/00; C02F 1/325; C02F 1/008; B01D 35/147; C02F 2201/32; C02F 2303/04

(57) ABSTRACT

A water treatment system is capable of meeting the particular needs of a variety of water treatment system applications. For instance, the water treatment system may include a customizable display, multiple interchangeable filters and disinfection systems. In one embodiment, a vessel containing the filters and disinfection assembly can be easily removed from a base that supplies water to the vessel. In another embodiment, the water treatment system includes a plate that includes at least one electrical connection. One or more electronics bricks with sensors, displays and the like can be removably attached to the plate such that each electronics brick is in electrical communication with said brick. In another embodiment, the water treatment system incorporates one or more stackable and interchangeable filter blocks that direct water flowing into the vessel through each filter media.

The present invention is directed to water treatment system (WTS) units, and more particularly to point-of-use home or commercial WTS units.

Water treatment systems are commonly used to treat water in a distribution system. A water treatment system removes pathogens, chemical contaminates, and turbidity from water that is used for human consumption. Water treatment systems may employ filtration components, ion exchange components, ultraviolet radiation components and the like to treat water as it flows through the water treatment system from a water supply to a point of distribution, for example, a faucet in a building.

Conventional water treatment systems connect a municipal or private pressurized water supply to a water distribution system. For example, an under-counter water treatment system, of the type used in residences or businesses, provides fluid communication between a pressurized water supply line and a faucet. As the water flows through the system, the system treats the water before it exits the faucet.

A typical WTS unit includes an inlet for untreated water from a water supply, a filtration system for filtering out contaminates, a disinfection system for treating or removing other contaminates, and an outlet for transferring the treated water to a faucet or a downstream device such as a beverage dispenser, ice maker, coffee mater or the like. WTS units often have a display and a user interface for indicating to the consumer various conditions, such as water quality, time of use and filter life.

Although current models of water treatment systems have become effective at removing and treating contaminates, they suffer from a common drawback in that most models are “one size fits all” with respect to filtration, disinfection and design. For example, most models are configured to use one specific filtration unit and/or one specific disinfecting unit. They work well for many water types and uses, but users are unable to configure or adapt them to meet a particular need. In addition, most WTS units are designed with a specific display configuration and a specific external housing configuration—regardless of the application in which it will be used. As a result, a WTS unit used in a countertop application may not have the most desired appearance, such as a large graphic heavy display, and a device mounted in an under-the-counter application may be difficult to access for maintenance purposes.

### SUMMARY OF THE INVENTION

The embodiments of the present invention provide a water treatment system capable of meeting the particular needs of a variety of water treatment system applications. The water treatment system may include a customizable display, multiple interchangeable filters, and disinfection systems.

In one embodiment, the water treatment system is adapted particularly for difficult-to-reach installation locations by providing a vessel containing the treatment assembly that can be easily removed from a base and moved to a different location, for instance, for changing the filters. The base may include a first flow path and a second flow path for directing water into and out of the vessel. When the vessel is positioned on the base, the an inlet on the vessel is in fluid communication with the first flow path and an outlet on the vessel is in fluid communication with the second flow path. Portions of the base may be movable to accommodate for the removal of the vessel from the base.

In another embodiment, the water treatment system provides an aesthetically pleasing exterior arrangement for installation in a more visible setting. The water treatment system again includes a vessel containing a treatment assembly, such as a water filtration media or a water disinfecting assembly. A plate is connected to the vessel, and the plate includes at least one electrical connection. At least one electronics brick is removably attached to the plate such that the electronics brick is in electrical communication with the plate. The electronics brick includes electronic circuitry and may include sensors for communicating with the filters or disinfecting assembly, a visual display, and other features. In one embodiment, the plate includes a series of attachment members spaced along the plate for snap-fitting to various sizes of electronic bricks. A plurality of electronic bricks may be arranged on the plate to meet the user's desired application.

In another embodiment, the water treatment system incorporates one or more stackable and interchangeable filter blocks, which enables a user to configure the treatment system for removal of a specific type of contaminant that may be particularly prevalent in the water. In this embodiment, a baffle may be positioned within the vessel. The filter blocks are stacked within the vessel, with each filter block including a filter media, a top end cap on a top surface of the filter media and a bottom end cap on a bottom surface of the filter media. The top and bottom end caps are arranged to create a flow path through each of the filter medias. For instance, the top end caps may seal against the baffle and the bottom end cap may seal against the sidewall of the vessel to direct water flowing into the vessel across the top end cap of each filter block and through each filter media.

### BRIEF DESCRIPTION OF THE DRAWINGS

FIG. 1 is a perspective view of a WTS according to a first embodiment of the present invention.

FIG. 2 is a rear perspective view thereof.

FIG. 3 is a view of the WTS in a partially open position.

FIG. 4 is another view of the WTS in a partially open position.

FIG. 5 is another view of the WTS in a partially open position.

FIG. 6 is a view of the WTS with the main housing portion partially removed.

FIG. 7 is an exploded view thereof.

FIG. 8 is a view of the WTS with the UV bulb partially removed.

FIG. 9 is a view of the WTS with the filter assembly removed.

FIG. 10 is a perspective view of the WTS with an alternative display cover.

FIG. 11 is a perspective view of a WTS according to a second embodiment of the present invention.

FIG. 12 is a bottom view thereof.

FIG. 13 is a rear perspective view thereof.

FIG. 14 is an exploded view thereof.

FIG. 15 is a perspective view thereof with a top portion removed.

FIG. 16 is a perspective view thereof with the UV bulb partially removed.

FIG. 17 is a perspective view thereof with a water routing mantle and a disinfection assembly partially removed.

FIG. 18 is a perspective view thereof with a filer assembly partially removed.

FIG. 19 is an exploded view of the filter assembly.

FIG. 20 is another exploded view of the second embodiment.

FIG. 21 is an exploded view of the electronics book.

FIG. 22 is a partial exploded view of the base assembly of the second embodiment.

FIG. 23 is an exploded view of the top lid of the second embodiment.

FIG. 24 is an exploded view of a UV bulb assembly.

FIG. 25 is an exploded view of an alternative filter assembly.

FIG. 26 is a view of the water routing mantle with the mantle plug removed.

FIG. 27 is a perspective view of a WTS according to a third embodiment of the present invention.

FIG. 28 is a perspective view of the WTS with an alternative top cap.

FIG. 29 is a rear perspective view of the WTS.

FIG. 30 is a rear perspective view of the WTS with a tube connector removed.

FIG. 31 is an exploded view of the WTS.

FIG. 32 is a cross sectional view showing flow through the filter assembly.

FIG. 33 is a partially exploded view of the WTS.

FIG. 34 is a perspective view of the filter assembly of the WTS.

FIG. 35 is an exploded view of the filter assembly.

FIG. 36 is another exploded view of the filter assembly.

FIG. 37 is an exploded view of a UV assembly.

FIG. 38 is a perspective view of a WTS according to a fourth embodiment of the present invention.

FIG. 39 is an exploded view thereof.

FIG. 40 is another exploded view thereof.

FIG. 41 is an exploded view of the base portion of the fourth embodiment.

FIG. 42 is a perspective view of a fifth embodiment of the present invention.

FIG. 43 is a perspective view thereof with the electronics portion separated from the treatment portion.

FIG. 44 is a perspective view thereof with a closure lid pivoted to an open position.

FIG. 45 is an exploded view of the treatment portion thereof.

FIG. 46 is a cross sectional view of the treatment portion thereof.

FIG. 47 is an exploded view of a filter assembly.

FIG. 48 is a perspective view of a filter assembly.

FIG. 49 is a perspective view of the fifth embodiment with the display removed.

FIG. 50 is a bottom perspective view of the fifth embodiment with the display removed.

FIG. 51 is a bottom perspective view of the fifth embodiment.

FIG. 52 is a bottom perspective view of the fifth embodiment including a vertical swivel mount.

FIG. 53 is a bottom perspective view thereof with the treatment portion removed.

FIG. 54 is a perspective view of the fifth embodiment including a horizontal mounting bracket with the pressure vessel partially removed.

FIG. 55 is a rear perspective view of the fifth embodiment with the horizontal mounting bracket.

FIG. 56 is a front perspective view of the fifth embodiment including a secondary filter housing.

FIG. 57 is an exploded view thereof with the secondary treatment portion removed.

FIG. 58 is an exploded view of the secondary treatment portion.

FIG. 59 is a perspective view of the fifth embodiment including a dispenser attachment.

### DESCRIPTION OF THE CURRENT EMBODIMENTS

The present application discloses multiple embodiments of a point-of-use water treatment system (WTS). The embodiments disclosed herein provide various configurations for a WTS, each of which utilizes modular components that can be adapted to meet the needs or requests of particular users. Although each embodiment is disclosed with a different set of features and components, it is to be understood that none of the disclosed feature sets is exclusive to any one embodiment.

### I. First Embodiment

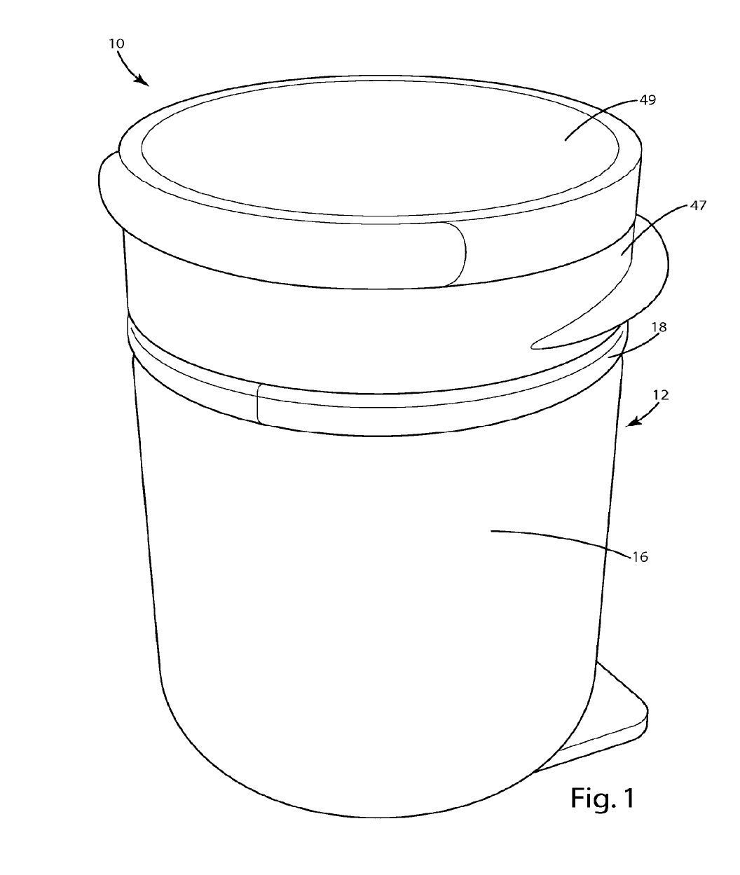

A point-of-use water treatment system according to one embodiment of the present invention is shown in FIGS. 1-10 and generally designated 10.

The embodiment illustrated in FIGS. 1-10 provides a WTS with a main housing 12 that is quickly and easily removable from a base portion 14. This enables a user to disconnect the main housing 12 from the base portion 14—which is commonly mounted in a particularly difficult to reach location, such as under the sink—and move it to a more comfortable location for maintenance purposes.

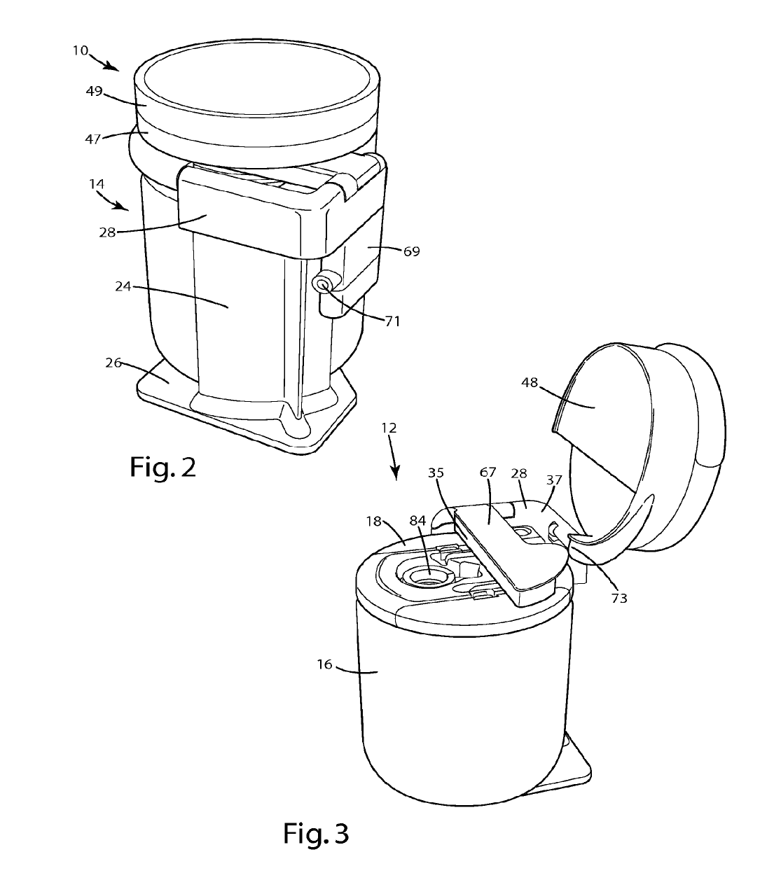

Referring to FIGS. 1 and 2, the main housing 12 includes a bucket 16 and a water mantle cover 18. The base portion 14 generally includes a backbone 24, a backbone base 26, and a backbone top 28. A water router 35 and an electronics tray 47 with display cover 49 also attach to the base in a hinged relationship, such that the water router 35 and electronics tray 47 can each be pivoted to open positions for easy removal of the main housing 12. Referring now to FIG. 3, the bucket 16 is a generally cylindrical vessel with an opening 30 at one end. The sidewall 32 of the bucket 16 includes an upper edge 34 that defines the opening 30. In the illustrated embodiment, the sidewall 32 includes an indentation 36 extending around the circumference of the bucket 16 adjacent to the upper edge 34.

In the illustrated embodiment, the backbone base 26 attaches to the lower edge 23 of the backbone 24 and provides a structure for attaching the base portion 14 to a mounting surface (not shown) and for supporting the main housing 12. In one embodiment, the WTS 10 may not include a backbone base 26, and instead the backbone 24 itself, or another portion of the base portion 14, may be attached to a mounting surface. As shown, the backbone 24 is approximately the same height as the main housing 12, and includes a top edge 25 that is configured to attach to the backbone top 28. The backbone top 28 includes a lower surface 31 that seats on the top edge 25 of the backbone 24, a first hinge receptacle 33 for receiving a hinged water router 35 and a second hinge receptacle 37 for receiving the hinged electronic tray 47 and flip display 49. The backbone 24 may include a protrusion 21 extending upwardly from the backbone top 28 for interfitting with a hole 27, or indentation, on the water mantle cover 18 to properly position the main housing 12 on the base 14.

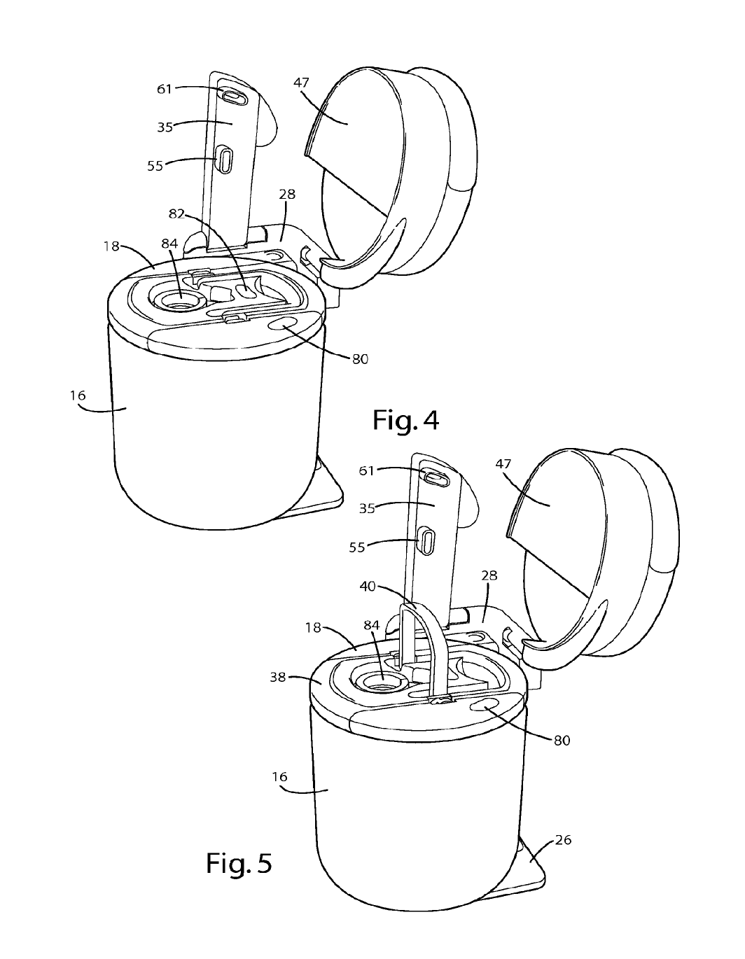

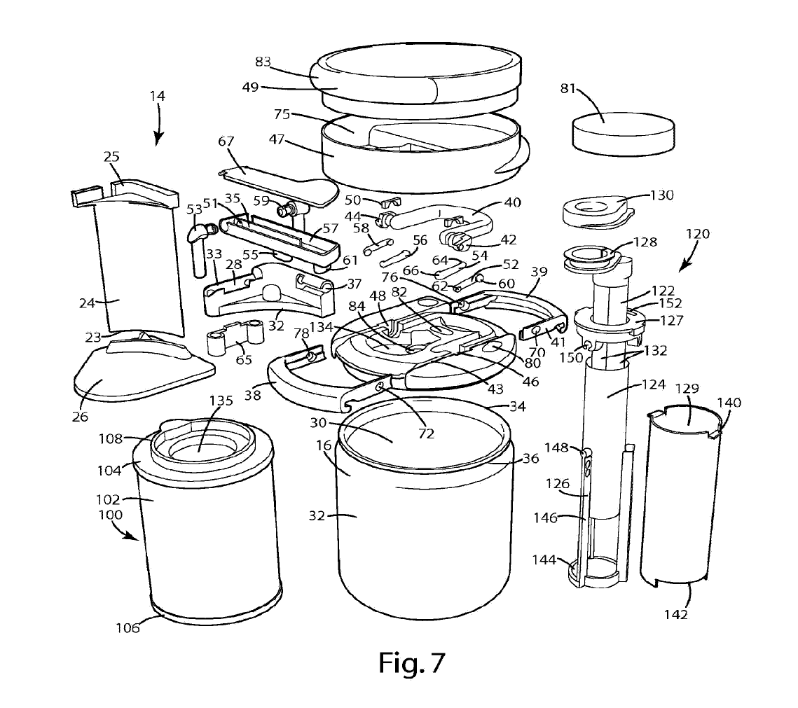

As shown in FIGS. 3-6, the water router 35 defines two internal channels for routing water into and out of the WTS 10. A first channel 51 fluidly interconnects with a tubular outlet hinge member 53 on one end of the router 35 and with an outlet boss 55 in approximately the middle of the router 35. A second channel 57 fluidly interconnects with a tubular inlet hinge member 59 at one end of the router 35 and an inlet boss 61 at the opposite end. The tubular hinge members 53 and 59 interfit with the first hinge receptacle 33, for instance, by snap fitting into opposite sides of the receptacle 33, and also interfit with the water router 35 such that the water router can pivot about the hinge members 53, 59 between a first (or “closed”) position, shown in FIG. 3, and a second (or “open”) position, shown in FIGS. 4-6. A water router cover 67 may be attached over the water router 35 to close and seal the water router 35. A variety of tube connectors, such as the tube connector 65 shown in FIG. 7, may be connected to the ends of the tubular hinge members 53 and 59 for attaching the WTS to conventional tubing and piping ends (not shown). An alternative tube connector 69, shown in FIG. 2, may include an additional port 71 or ports in fluid communication with the inlet or outlet tubular hinges to enable easy connection to a downstream device, such as a beverage dispenser, or an upstream device, such as another water treatment stage or device.

In one embodiment, the electronic tray 47 includes a hinge portion 73 that extends into the second hinge receptacle 37 in the backbone top 28 to pivotally connect the electronics tray 47 to the backbone top 28 such that the electronic tray 47 can pivot between a first (“closed”) position, shown in FIG. 2, and a second (“open”) position, shown in FIG. 3-6. As shown in FIG. 7, in one embodiment, the electronic tray 47 includes an interior cavity 75 for housing a variety of electronic components that may be utilized by the WTS 10, such as power supplies, sensors, controllers and associated circuitry. In one embodiment, the WTS may utilize an inductively coupled ballast circuit, such as that disclosed in U.S. Pat. No. 6,825,620 (the content of which is hereby incorporated by reference) to power one or more components, including a UV lamp for a UV disinfection module. The inductively coupled ballast circuit enables electrical connection between a power supply and a load without a direct electrical connection, such as wires or soldered leads and without a removable electric connection, such as plugs or other connectors. The ballast circuit—including a primary coil—may be housed in the electronics tray 47. In the embodiment shown in FIG. 7, the ballast circuitry for powering a UV lamp is shown schematically as a cylindrical disk 81, which is housed in the electronic tray 47.

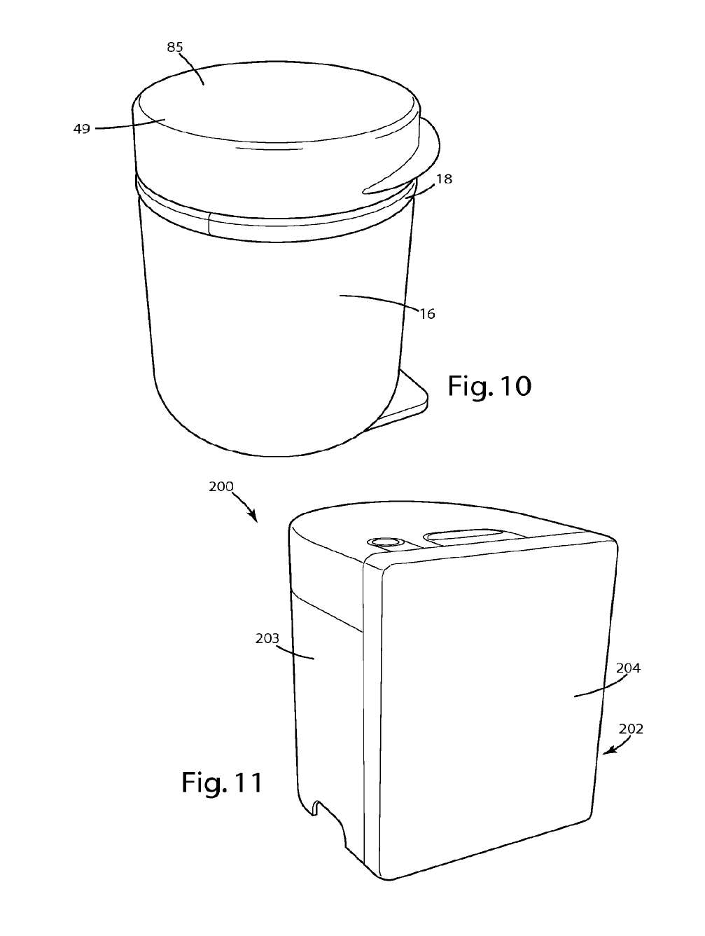

The display cover 49 is sized to interfit with the electronics tray 47, for instance, by snap fitting into the electronics tray 47 or by threads or another fastening method. The display cover 49 may accommodate a wide variety of displays, such as an LCD display or another conventional display on the side edge 83 of the display cover 49 for displaying a variety of characteristics about the WTS 10, such as filter status, power status, and water quality. In one embodiment, shown in FIG. 10, the display cover 49 may include a dome shaped upper surface 85, which may be transparent, or include a transparent portion, for including a display directly on or through the upper surface 85. In one embodiment, the display cover 49 may rotate within the electronics tray 47 to allow a user to adjust the direction for viewing the display.

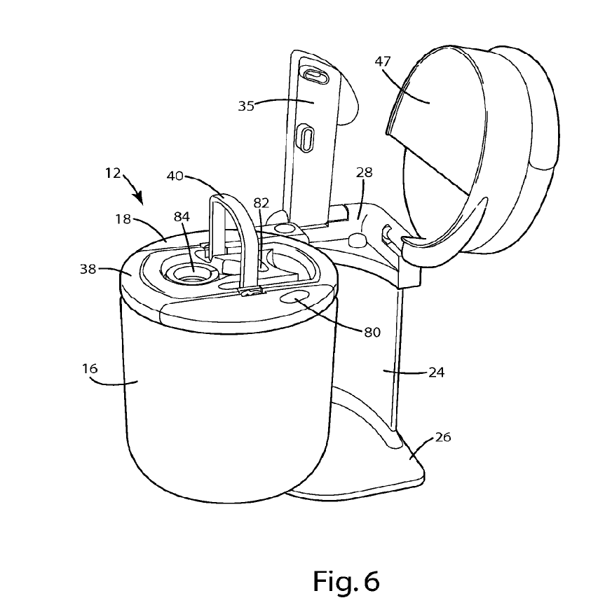

The water mantle cover 18 fits over the upper edge 34 of the bucket 16 to close the bucket 16 and provide inlet and outlet ports for the water. As illustrated, the water mantle cover 18 includes a pair of slide closures 38, 39 positioned on opposite sides of the cover 18. The slide closures 38, 39 can be actuated by movement of the handle 40 to slide between a closed position, shown in FIG. 4, an intermediate position, shown in FIGS. 5-6, and an open position, shown in FIG. 9. The slide closures 38, 39 each include a pair of legs 41 that are slidably received in slots 43 in the water mantle cover 18. Referring now to FIG. 7, the handle 40 includes a pair of cams 42, 44 on opposite sides of the handle 40. The cams 42, 44 fit into recesses 46, 48 in the water mantle cover 18 and are held in place with snap covers 50. The cams 42, 44 are connected to the slide closures 38, 39 with slide links 52, 54, 56 and 58. In particular, a protrusion 60 at one end of the slide link 52 fits into an elongated slot 70 in one side of the slide closure 39, and a protrusion 62 at the opposite end of the slide link 52 fits into a hole in the cam 42. Similarly, a protrusion 66 at one end of the slide link 54 fits into an elongated slot 72 in the slide closure 38 and a protrusion 64 at the opposite end of the slide link 54 fits into a hole in the rear surface (not shown) of cam 42. The slide links 56, 58 attach to the cam 44 and elongated slots 76, 78 in the slide closures 38, 39 in the same configuration. This arrangement causes the slide links 52, 54, 56 and 58 to pull the slide closures 38, 39 closed when the handle 40 and cams 42, 44 rotate to the closed position, and further causes the slide links to extend to push open the slide closures 38, 39 when the handle 40 and cams 42, 44 are rotated to the open position. The elongated shape of the slots 70, 72, 76 and 78 permits some movement of the slide links 52, 54, 56, 58 within the slots, so that the slide closures 38, 39 remain in the closed position until the handle is rotated open past about 90 degrees. In this way, the handle 40 can be used to lift the entire main housing 12 when the handle 40 is opened only to the 90 degree position, as shown in FIGS. 5 and 6.

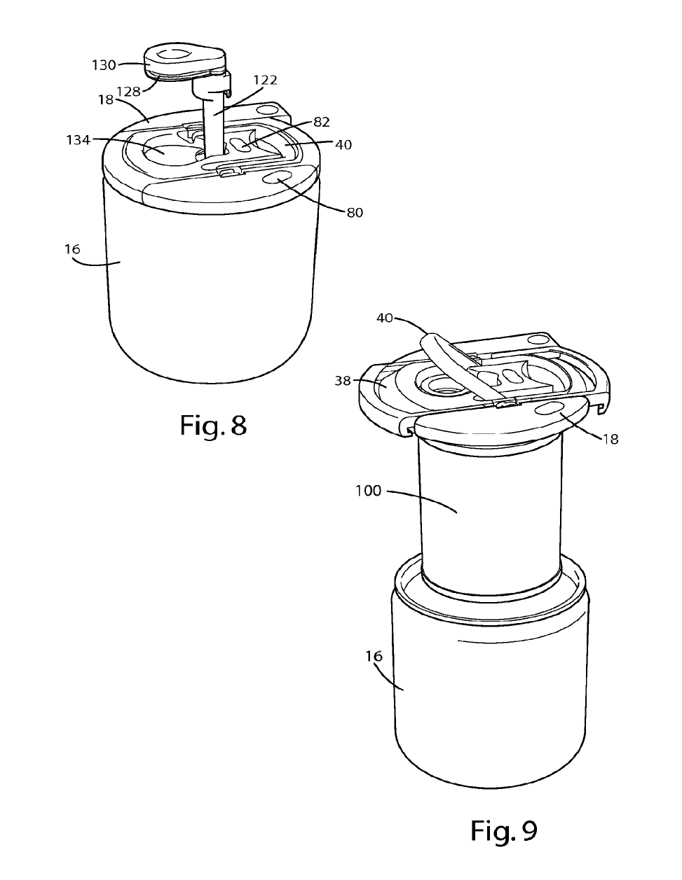

The water mantle cover 18 additionally provides access ports to the inside of the bucket 16. As shown in FIG. 4, in one embodiment, the water mantle cover 18 includes an inlet port 80 for providing untreated water into the bucket 16 and an outlet port 82 for treated water exiting the bucket 16. When the water router 35 is pivoted into the first (i.e. closed) position, the inlet boss 61 is inserted into the inlet port 80 on the water mantle cover 18 and the outlet boss 55 is inserted into the outlet port 82 on the water mantle cover 18 to allow fluid to flow into the WTS 10 via the tubular inlet hinge member 59, the inlet channel 57 and the inlet boss 61 and to allow fluid to flow out of the WTS 10 via the outlet boss 55, the outlet channel 51 and through the tubular outlet hinge member 53. In addition, the water mantle 18 includes an access port 84 for insertion and removal of a UV lamp 122 (described in more detail below). FIG. 8 shows the UV lamp 122 partially removed from the water mantle cover 18 through the access port 84.

The WTS 10 may be provided with a variety of filtration and/or disinfection devices for treating the water directed through the system. In one embodiment, the WTS 10 includes a primary filter assembly 100 and a disinfection assembly 120 that are sized to fit within the interior of the bucket 16 such that water can be routed through each of the assemblies 100, 120 to remove contaminates and disable microorganisms before exiting the WTS 10 as treated water.

In one embodiment, the filter assembly 100 is a cylindrical carbon block filter assembly and the disinfection assembly 120 is a UV lamp assembly that is positioned within the center of the cylindrical carbon block, similar to the arrangement disclosed in U.S. Pat. No. 6,451,202 to Kuennen, the content of which is incorporated by reference herein. In the illustrated embodiment, the filter block 100 includes a filter media 102 and a pair of end caps 104, 106. In one embodiment, the end caps 104, 106 may be formed from a resilient material, such as a resilient elastomer or rubber, that forms a leak tight seal between the water mantle cover 18 and the bottom of the bucket 16 when the water mantle cover 18 is closed over the opening 30 of the bucket 16. The filter media 102 may have a variety of configurations and may be formed from a variety of materials for filtering a desired amount or type of particulate from the water. In one embodiment, the filter media 102 is a carbon block filter such as the carbon block filter disclosed in U.S. Pat. No. 6,368,504 to Kuennen, the content of which is incorporated by reference herein, wherein the carbon block includes activated carbon particles and a binder, and the carbon particles have a mean particle diameter ranging from about 60 microns to about 80 microns and wherein the carbon particles have a particle size distribution in which no more than about 10% by weight of the carbon particles are larger than about 140 mesh and no more than about 10% by weight of the carbon particles are smaller than about 500 mesh. Alternatively, the filter media 102 could be provided with a different carbon mixture. In yet another alternative, the filter media 102 could be a paper filter, such as a pleated paper filter, or a pleated woven filter, or a resin bead material, or another type of filter media, such as a hollow fiber membrane filter. In one embodiment, two or more types of filter media may be provided in a layered configuration, with one filter media extending around the outside of at least a portion of a second filter media. The outer filter layer could be attached to the inner filter layer as a unitarily removable filter block, or it could be provided as a separately removable cylinder that can be inserted around the outside of the inner layer. One particular embodiment includes a pleated woven prefilter (not shown) that extends around a carbon block. In the illustrated embodiment, the upper end cap 104 of the filter assembly 100 includes a flange 108 that extends upwardly and seals against the water mantle cover 18 when the cover 18 is in place. The flange 108 is positioned inside the water inlet port 80 in the water mantle cover 18, forcing the water entering the bucket to flow around the outside of the filter media 102, between the filter media 102 and the sidewall 32 of the bucket 16 before flowing radially inwardly through the filter media 102. In one embodiment, the WTS 10 may be provided only with a filter assembly 100, and no disinfection assembly 120. In this embodiment, water flowing through the filter media 102 flows radially inwardly through the filter media 102, into the hollow space within the center of the filter media 102, and exits through the outlet port 82.

In the illustrated embodiment, the optional disinfection assembly 120 is a ultraviolet (UV) reactor. A variety of UV reactors are known for use in water treatment and could be used in the WTS 10, including the UV reactor disclosed in U.S. Pat. No. 6,451,202 to Kuennen. The UV assembly provides UV radiation necessary to disable many microorganisms passing through the WTS 10. As illustrated in FIG. 7, the UV reactor 120 includes a UV lamp 122, a quartz tube 124, a UV reactor baffle 126, a baffle seat 127, secondary electronics 128, a reactor housing 129 and a UV lamp cover 130.

The UV lamp 122 includes two side-by-side emitting bulbs 132 that are electrically connected to the secondary electronics—including a secondary coil—so that the bulb can be inductively powered via the electrical connection between the primary 81, located within the electronics tray 47 positioned above the UV lamp, and the secondary 128. The UV lamp is individually removable from the rest of the UV reactor, and from the WTS 10, by insertion and removal of the UV lamp 122 through the UV access port 84 in the water mantle cover 18. When the lamp 122 is inserted, the secondary electronics 128 of the UV lamp fit within a recess 134 in the water mantle cover 18 and are covered by the UV lamp cover 130, which may snap-fit in place within the recess 134. The remaining components fit within the interior opening 135 in the cylindrical filter media 102.

The UV reactor housing 129 is generally cylindrical, with a diameter that is slightly smaller than the diameter of the opening 135 of the filter media 102 so the reactor housing fits within the opening 135. As shown, the reactor housing 129 includes a pair of tabs 140 that extend outwardly from the upper edge of the housing 129. The tabs 140 engage the baffle seat 127 to provide alignment for the UV assembly. The reactor housing 129 further includes a cutout 142 at the bottom edge of the housing 129 to provide a water path inlet for the UV assembly 120. The size of the inlet could be varied, depending on the desired volume of water flow through the UV reactor. The baffles 126 generally include a base 144 and three prongs 146 extending upwardly from the base 144, which act as spacers between the reactor housing 129 and the quartz sleeve 124 to provide a multiple chamber water flow path. As shown, the end of each prong 146 includes a knob 148 that fits within a similarly shaped receptacle 150 in the baffle seat 127 to retain the baffle 126 on the baffle seat 127. The quartz tube 124 fits between the prongs of the baffle 126 and surrounds the UV bulbs 132 when the lamp assembly 122 is inserted, while transmitting UV light into the fluid path between the quartz tube 124 and the reactor housing 129 when the light is turned on. The baffle seat 127 rests on the top end cap 104 of the filter assembly 100 and includes an outlet port 152 that aligns with the outlet port 82 in the water routing mantle 18 to allow water to exit the UV assembly, and, ultimately, the WTS 10 after it has been treated.

In operation, water flowing through the filter media 102 flows into the UV reactor assembly through the cutout 142 in the reactor housing 129 and up through the gap between the housing 129 and the quartz tube 124 wherein the UV light disables microorganisms within the water as the water flows through the multiple chambers partitioned by the baffles 126, illustrated in this embodiment by three compartments, and, finally, out of the main housing through the outlet port 152. Water may enter the UV assembly 120 through the cutout 142 in the reactor housing 129 and flow into the first chamber 121. Water may then flow up the first chamber 121 and exit through openings 123 in the top of prong 146 to enter into the second chamber 125, and then flow down and exit through openings 131 in the bottom of the next prong 146 to enter the third chamber 133. Finally, water may exit the UV reactor through the outlet portion 152.

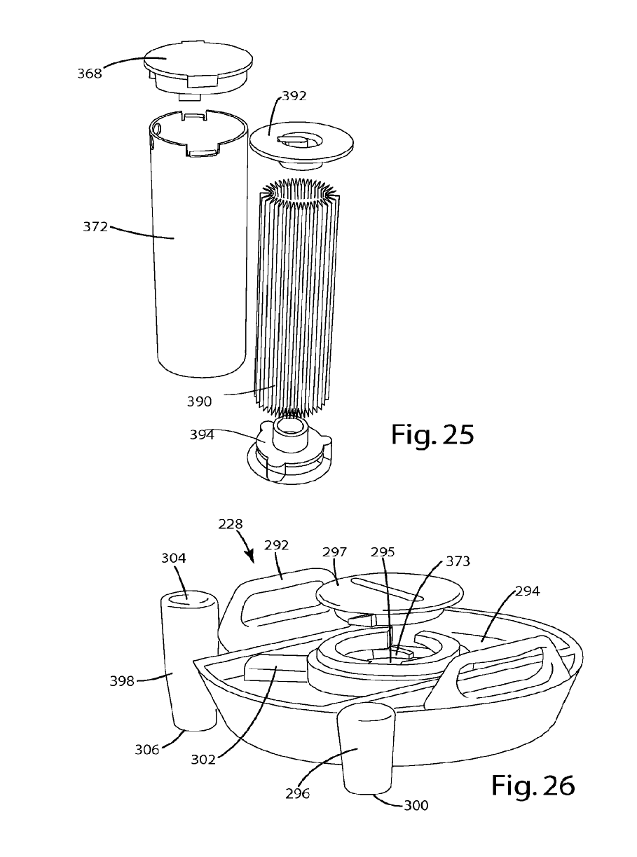

Although the illustrated embodiment includes a UV reactor, other disinfection assemblies could be used, such as chlorine, brominated polystyrene beads or another chemical, contact biocide technology (manufactured and distributed by HaloSource, Inc., of Bothell, Wash.), electropositive nanofiber filter media (manufactured and distributed by Ahlstrom Corp. of Helsinki, Finland) such as that shown in FIG. 25 in connection with the second embodiment, ultrafiltration, or another type of disinfection treatment assembly.

In one embodiment, the filter assembly 100 and the disinfection assembly 120 may each include an information tag (not shown) attached to or fitted within the assembly. The information tag is used to store information about the particular filter or assembly in use, and to record parameters related to such use. Sensors within the electronics tray 47 inductively power and communicate with the information tags to obtain details regarding the stored information and parameters recorded. The parameters obtained by the sensors may be displayed on the display cover 49. They may also be used to adjust the performance of the WTS controls to accommodate the characteristics of the component.

The easy removal of the main housing 12 from the base portion 14 is shown in FIGS. 3-6. As shown in FIG. 3, the electronics tray 47 and display cover 49 may be pivoted to the open position to reveal the water router 35 and water mantle cover 18. The water router 35 can then be pivoted to the open position to separate the water inlet 61 and outlet 55 from the main housing 12, and the main housing 12 can be lifted with the handle 40 and removed from the base portion 14. In this position, with the handle rotated to approximately a 90 degree position, the main housing 12 can be carried to a convenient location for maintenance and/or filter change. In this position, the UV lamp 122 can be removed and replaced. Finally, when the handle 40 is pivoted past the 90 degree point (as in FIG. 9) the slide closures 38 and 39 open and the water mantle cover 18 can be removed to provide access to the filter assembly 100 and the remainder of the disinfection assembly 120.

### II. Second Embodiment

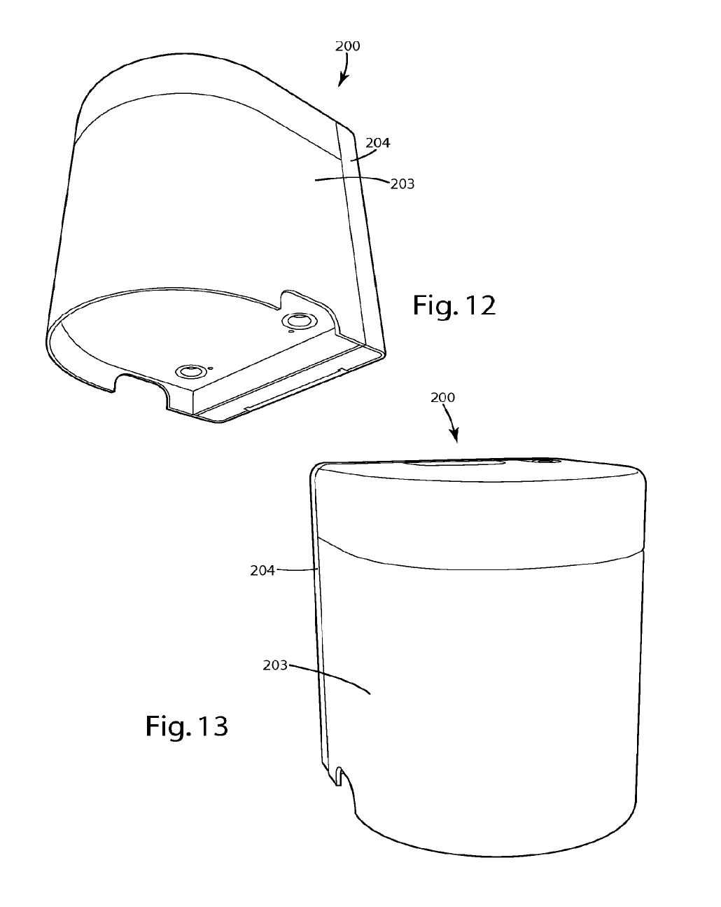

A WTS according to a second embodiment of the present invention is shown in FIGS. 11-26 and generally designated 200.

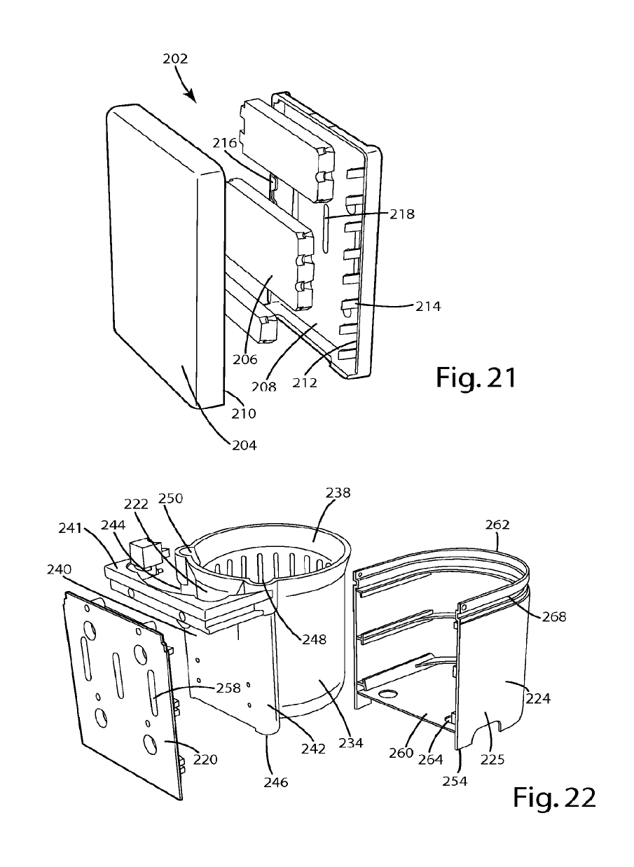

The embodiment illustrated in FIGS. 11-26 provides a large, aesthetic display 202 that attaches to a main housing 203 and can be configured with a variety of display options as desired. As shown in FIG. 11, the display 202 includes a front face 204 that covers the entire front of the WTS unit 200. The front face 204 forms the outer surface of an electronics “book,” shown in more detail in FIG. 21, that houses one or more removable electronic “bricks” 206 between the front face 204 and a back plate 208. The front face 204 provides a display face for displaying a variety of information about the WTS 200 and components within the WTS 200. In one embodiment, the display face 204 is translucent or transparent, such that one or more displays, for example, LED displays, on the individual electronic bricks 206 are visible through the display face 204. In another embodiment, the display face may itself be a screen, such as a viewable LCD screen, a touch screen, a screen printed with electronic ink, or another alternate display. In one embodiment, the front face 204 includes a peripheral edge 210 that fits over the peripheral edge 212 of the back plate 208 and engages the face housing 220 of the main housing 203, discussed below.

The electronic bricks 206 may be any desired size or shape, although the bricks 206 shown in the illustrated embodiment have a standard width such that they snap fit with a series of first protrusions 214 on a first side of the back plate 208 and a series of second protrusions 216 on the opposite side of the back plate 208. Of course, other connection methods are possible. The bricks 206 may each include electronic circuitry and controls for one or more of a variety of options, such as sensors, power supplies and a battery backup. As noted above, each electronic brick may also include display features, for instance, for transmitting a display through a translucent or transparent front face 204. In one embodiment, the back plate 208 includes a built in electronic bus, such that each electronic brick 206 can be electrically connected to the WTS 200 via attachment to the back plate 208. The back plate 208 may include terminal blocks (not shown) or another type of electrical connection for removably connecting the electronic bricks 206 to the back plate 208. In this way, various electronic blocks 206 can be interchanged by a manufacturer or by any end user to customize the features of the WTS 200 as desired. The back plate 208 may additionally include one or more elongated slots 218 extending through the back plate 208. The slots 218 align with information tags, such as RFID chips, positioned within the components of the main housing to enable sensors in the electronic bricks 206 to effectively communicate with the information tags. The slots 218 align with inlet and outlet pathways 242, 244 contained within pressure tank 222 of the WTS to enable sensors in the electronic bricks 206 to effectively communicate flow, pressure, temperature or other attributes.

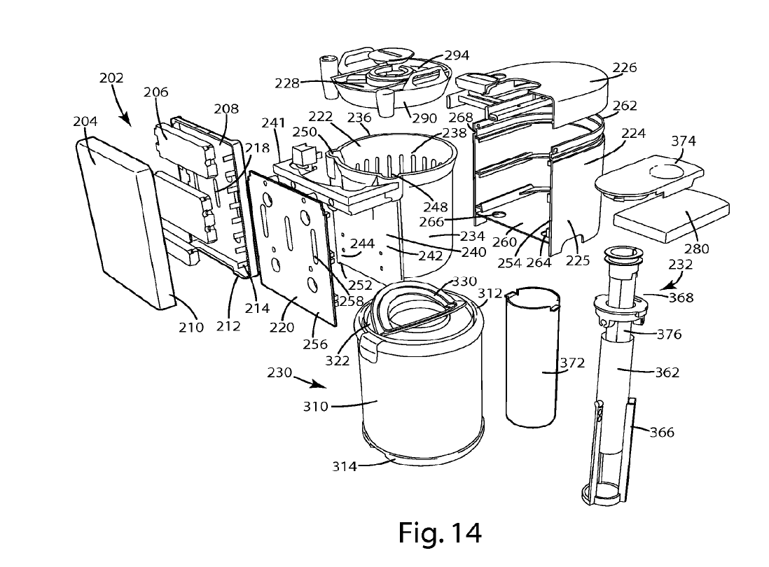

The main housing 203 generally includes face housing 220, pressure tank 222, back housing 224, top lid 226, water routing mantle 228, primary filter assembly 230 and a disinfection module 232. The pressure tank 222 acts as the structural housing for the WTS 200. Referring to FIG. 14, the pressure tank 222 is a generally cylindrical vessel with a sidewall 234 and an upper edge 236 that defines an opening 238. However, the front portion 240 of the pressure vessel 222 is generally flat, and it includes two enclosed, integrally formed, tubular pathways 242 and 244 for directing water into and out of the WTS 200 through the bottom of the unit. Referring to FIGS. 14 and 22, the first tubular pathway 242 is an untreated water inlet that includes an entrance 246 at the bottom of the pressure tank 222 and an exit 248 at the top of the pressure tank 222. The second tubular pathway 244 is a treated water outlet that includes an entrance 250 at the top of the pressure tank 222 and an exit 252 at the bottom of the pressure tank 222. The tubular pathways both flare outwardly near the top end 236 of the pressure tank 222 to form receptacles for the inlet and outlet portions of the water routing mantle 228 (discussed in more detail below). In one embodiment, the front portion 240 is formed from a plastic material so that any information tags positioned within the pressure tank 222 can communicate with sensors or other electronics positioned in one of the electronic bricks 206. In another embodiment, the entire pressure tank 222 is integrally formed from the same plastic material. The face housing 220 and a top dress plate 241 form an interface between the pressure tank 222 and the display 202. More particularly, the top dress plate 241 attaches to the front portion 240 of the pressure tank 222 near the top edge 236, and the face housing 220 attaches to the top dress plate 241 and the front portion 240 of the pressure tank 222. A front surface 256 of the face housing 220 attaches to the back plate 208 of the display 202. In one embodiment, the face housing 220 is made from a plastic material, and includes one or more slots 258 extending through the front housing 240 to allow communication through the front housing 240 between the electronic bricks 206 and information tags in the pressure tank 222 and to allow communication between the electronic bricks 206 and components within inlet and outlet pathways 242, 244 contained within pressure tank 222. The slots 258 in the face housing 220 may align with the slots 218 in the back plate 208 of the display 202.

The back housing 224 includes a generally U-shaped sidewall 225 that is sized to receive the pressure tank 222. The back housing includes a forward edge 254 that engages with and attaches to the peripheral edge of the face housing 220 to form the aesthetic outer surface of the WTS 200. The back housing 224 further includes a bottom wall 260 and a top edge 262. The bottom wall 260 includes a first hole 264 that aligns with the entrance 246 of the water inlet tube 242 and a second hole 266 that aligns with the exit 252 of the water outlet tube 244. In this way, water can be inconspicuously routed into and out of the WTS 200 through the bottom of the unit. In one embodiment, the back housing 224 includes a notch 268 that extends around the sidewall 225 near the top edge 262 to slidably receive the top lid 226.

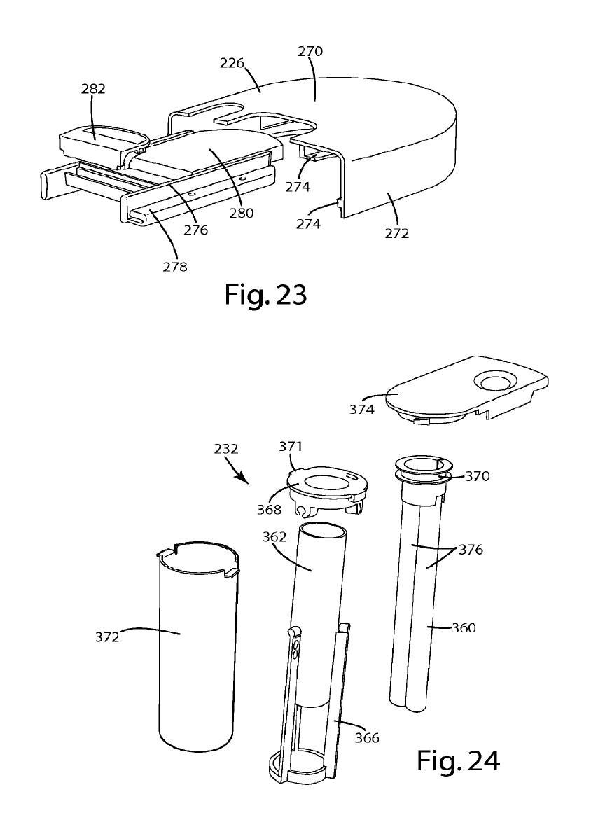

As illustrated, the top lid 226 is generally U-shaped to match the shape of the back housing 224. Of course, the shapes of each of the housing components could vary from application to application. The top lid 226 is designed to be removable from the WTS 200 to allow access to the filter assembly 230 and disinfection assembly 232. As shown in FIG. 23, the top lid 226 includes a top wall 270 and a sidewall 272. The sidewall 272 includes an inwardly extending protrusion 274 on the inner surface, which interfits with the notch 268 on the back housing 224 so that the top lid 226 slidably attaches to the back housing 224. In one embodiment, the top lid 226 further includes a pair of L-shaped flanges 274 that extend downwardly from the top wall 270 to slidably receive slide rail 276. The slide rail 276 includes a pair of U-shaped slides 278 that fit around the flanges 274 to support the slide rail 276 within the top lid 226. In one embodiment, the slide rail 276 supports the primary electronics 280 for an inductive ballast circuit as discussed above in connection with the first embodiment. The primary electronics 280 may be used to inductively power a secondary coil attached to a load, such as a UV lamp within the disinfection module 232. In addition, the top lid 226 includes a latch 282, attached to the slide rail 276, for engaging the top edge of the back plate 208 to retain the top lid 226 in place on the unit 200.

In one embodiment, the water routing mantle 228 is a generally circular plug that fits into the top edge 236 of the pressure tank 222. More particularly, the water routing mantle 228 may include a tapered sidewall 290 that wedges into the top edge 236 of the pressure tank 222 to provide a tight fit. A pair of handles 292 extend from the upper surface 294 of the mantle 228 for removing the mantle 228 from the WTS unit 200. In one embodiment, the mantle 228 includes a central hole 295 extending through the mantle 228 for easy insertion and removal of an optional UV lamp 360. In another embodiment, wherein the WTS 200 does not include the optional disinfection module 232, the water routing mantle 228 is provided with a plug 297 to seal off the hole 295. The plug 297 may attach to the mantle 228 with a bayonet style connection. As shown in FIG. 26, the mantle includes an inlet tube 296 and an outlet tube 298 extending from the sidewall 290. The inlet tube 296 includes an opening (not shown) in the bottom edge 300 which extends through the sidewall 290 of the mantle and exits through the bottom of the mantle 228 inside the pressure tank 222. The inlet tube 296 therefore directs water entering the WTS 200 through the inlet tube 242, through the mantle 228 and into the pressure tank 222 near the sidewall 234 of the pressure tank 222. The outlet tube 298 includes an entrance (not shown) within the central hole 295 of the mantle 228, a central portion 302 extending through the mantle 228, and a pair of exits 304, 306. The top exit 304 is directed towards the top of the WTS unit for directing the treated water through the top of the unit 200, and the bottom exit 306 aligns with the outlet tube 244 formed in the pressure tank 222 for directing the treated water out through the bottom of the WTS unit. A plug (not shown), or alternatively an internal valve, may be provided for sealing off the exit 304, 306 that is not in use.

The WTS 200 may be provided with a variety of filtration and/or disinfection devices for treating the water directed through the system. In one embodiment, the WTS 200 includes a primary filter assembly 230 and a disinfection assembly 232 that are sized to fit within the interior of the pressure tank 222 such that water can be routed through each of the assemblies 230, 232 to remove contaminates and disable microorganisms before exiting the WTS 200 as treated water.

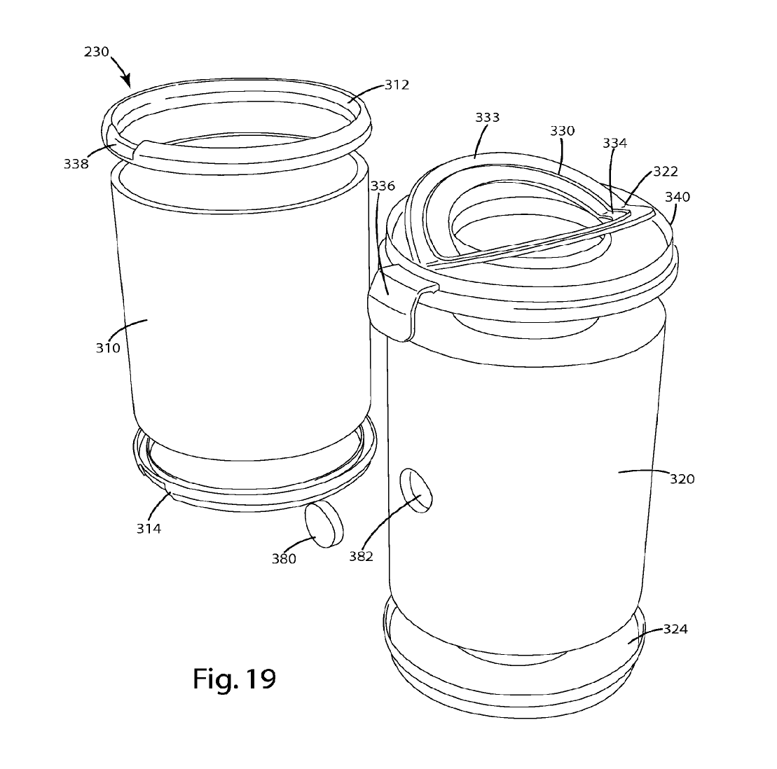

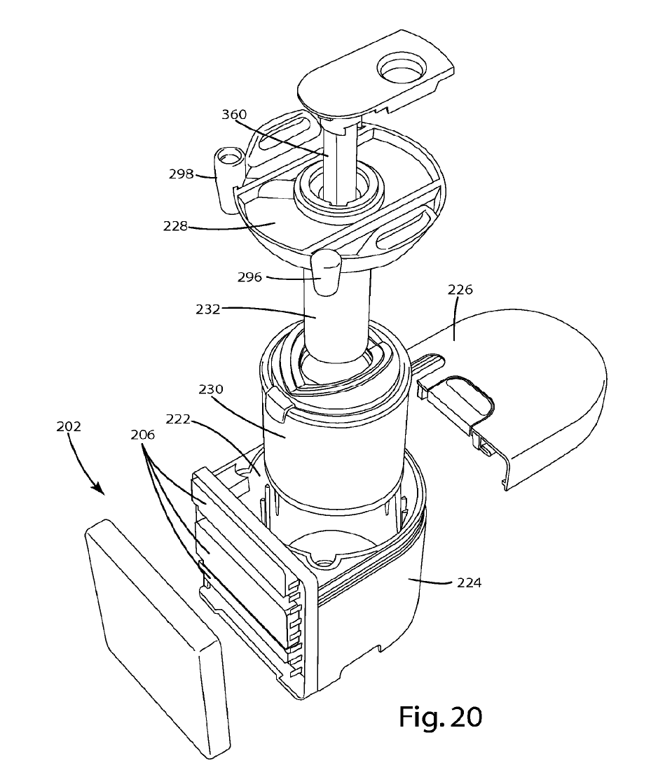

In one embodiment, the primary filter assembly 230 and the disinfection assembly 232 are substantially the same as the primary filter assembly 100 and the disinfection assembly 120 of the first embodiment, in that the primary filter assembly 230 is a cylindrical carbon block filter assembly and the disinfection assembly 232 is a UV lamp assembly that is positioned within the center of the cylindrical carbon block. In the illustrated embodiment, shown in FIG. 19, the filter block 230 includes an optional prefilter 310 having a pair of end caps 312, 314, and an inner filter media 320 having a pair of end caps 322, 324. In one embodiment, the end caps 312, 314, 322 and 324 may each be formed from a resilient material, such as a resilient elastomer or rubber, that forms a leak tight seal between the water mantle cover 228 and the bottom of the bucket pressure tank 222 when the water mantle cover 228 is closed over the opening 238 of the pressure vessel 222. In addition, the top end cap 322 of the inner filter media 320 may include an integral pop-up handle 330. In the illustrated embodiment, the handle 330 includes a pair of opposing flaps 333 that are formed unitarily with the top end cap 322 and attach to the top end cap 330 at a living hinge 334. When the water routing mantle 228 is removed from the pressure tank 222, the flaps 333 pop-up for ease in pulling the filter media 320 out of the pressure tank 222. In addition, the top end cap 322 may include a flange 336 that interfits with a groove 338 in the top end cap 312 of the optional prefilter 310 and a groove (not shown) in the pressure vessel 222 that provides an orientation key to assure the alignment of information tags that may be present in either or both filtration elements.

As in the first embodiment, the filter medias 310, 320 may have a variety of configurations and may be formed from a variety of materials for filtering a desired amount or type of contaminate from the water. In one embodiment, the inner filter media 320 is a carbon block filter such as the carbon block filter disclosed in U.S. Pat. No. 6,368,504 to Kuennen, wherein the carbon block includes activated carbon particles and a binder, and the carbon particles have a mean particle diameter ranging from about 60 microns to about 80 microns and wherein the carbon particles have a particle size distribution in which no more than about 10% by weight of the carbon particles are larger than about 140 mesh and no more than about 10% by weight of the carbon particles are smaller than about 500 mesh. Alternatively, the filter media 320 could be provided with a different carbon mixture. In yet another alternative, the filter media 320 could be a paper filter, such as a pleated paper filter, or a pleated woven filter, or a resin bead material, or another type of filter media, such as a hollow fiber membrane filter. In one embodiment, the prefilter 310 is a paper filter for removing larger particulates from the water, but the prefilter 310 may also be a variety of different types of filter media. In another embodiment, either the prefilter 310 or the inner filter 320 may include two or more types of filter media in a layered configuration, with one filter media extending around the outside of at least a portion of a second filter media. The outer filter layer could be attached to the inner filter layer as a unitarily removable filter block, or it could be provided as another separately removable cylinder that can be inserted around the outside of the inner filter media 320 or the prefilter 310. In the illustrated embodiment, the upper end cap 322 of the inner filter media 320 includes a flange 340 that extends upwardly and seals against the water mantle cover 228. The flange 340 is positioned inside the water inlet of the tube 296, forcing the water entering the pressure tank 222 to flow around the outside of the optional prefilter 310, between the prefilter 310 and the sidewall 234 of the pressure tank 222 before flowing radially inwardly through the prefilter 310 and the inner filter 320. In one embodiment, the WTS 200 may be provided only with a filter assembly 230, and no disinfection assembly 232 or prefilter 310. In this embodiment, water flowing through the inner filter media 320 flows radially inwardly through the filter media 320, into the hollow space within the center of the filter media 320, and exits through the outlet tube 298.

In the illustrated embodiment, the optional disinfection assembly 232 is a ultraviolet (UV) reactor, and functions substantially the same as the UV reactor described above in connection with the first embodiment. As illustrated in FIG. 24, the UV reactor 232 includes a UV lamp 360, a quartz tube 362, a UV reactor baffle 366, a baffle seat 368, secondary electronics 370, a reactor housing 372 and a UV lamp cover 374.

The UV lamp 360 includes two side-by-side emitting bulbs 376 that are electrically connected to the secondary electronics—including a secondary coil—so that the bulb can be inductively powered via the electrical connection between the primary electronics 280, located within the top lid 226 positioned above the UV lamp, and the secondary 370. The UV lamp is individually removable from the rest of the UV reactor, and from the WTS 200, by insertion and removal of the UV lamp 360 through the UV access hole 295 in the water mantle cover 228. When the lamp 360 is inserted, the secondary electronics 370 of the UV lamp fit above the central hole 295 in the water mantle cover 228 and are covered by the UV lamp cover 374, which may snap-fit in place within the recess 295 with a bayonet style attachment. The remaining components fit within the interior opening of the inner filter media 320, and in one embodiment the baffle seat 368 includes tabs 371 that connect to a groove 373 in the lower portion of the central hole 295 with a bayonet style attachment. This connection enables removal of the remaining components of the UV assembly when the water routing mantle 228 is removed. In operation, water flowing through the filter media 320 flows into the UV reactor assembly and out of the main housing through mantle 228 and the outlet tube 298. As noted above, a wide variety of alternative disinfection modules may be used in place of the UV reactor. FIG. 25 shows one alternative embodiment, wherein the disinfection module is an electropositive nanofiber filter media 390 with end caps 392, 394.

As in the first embodiment, the filter assembly 230 and the disinfection assembly 232 may each include an information tag attached to or fitted within the assembly. For example, as shown in FIG. 19, a information tag 380 may be inserted into a cutout 382 in the side of the inner filter media 320. The information tags are used to store information about the particular filter or assembly in use, and to record parameters related to such use. Sensors within the electronic bricks 206 inductively power and communicate with the information tags to obtain details regarding the stored information and parameters recorded. The parameters obtained by the sensors may be displayed by the display 202 and/or to adjust the operating parameters and controls of the system to accommodate each specific alternative component.

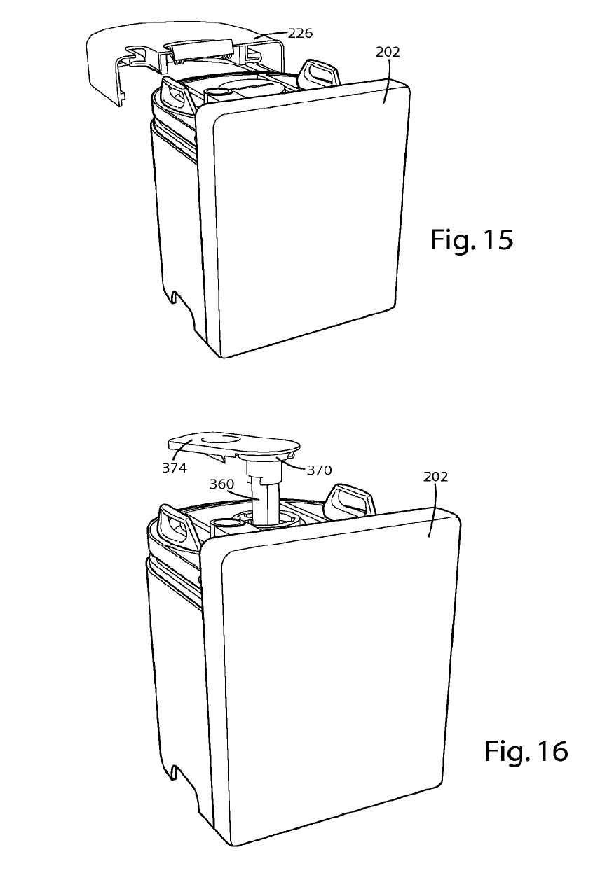

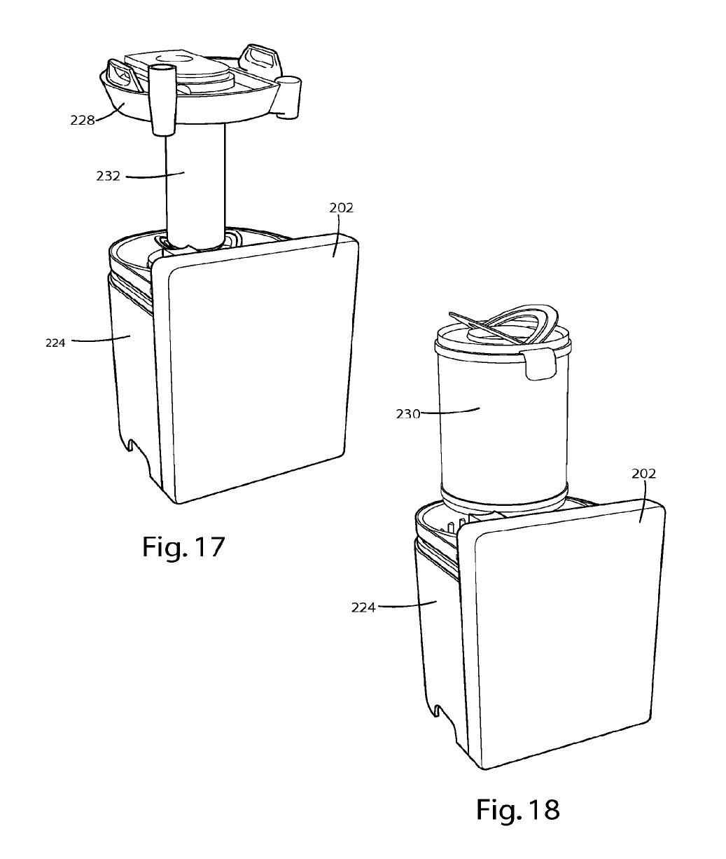

The easy removal of the filter assembly 230 and disinfection assembly 232 from the WTS 200 is shown in FIGS. 15-18. FIG. 15 shows the top lid 226 removed from the unit 200 by sliding it from the back housing 224. FIG. 16 shows the removal of the UV lamp 360 through the central hole 295 in the water routing mantle 228. FIG. 17 shows the removal of the water routing mantle along with the rest of the UV reactor assembly 232. FIG. 18 shows the removal of the filter assembly 230 with the pop-up handle 330.

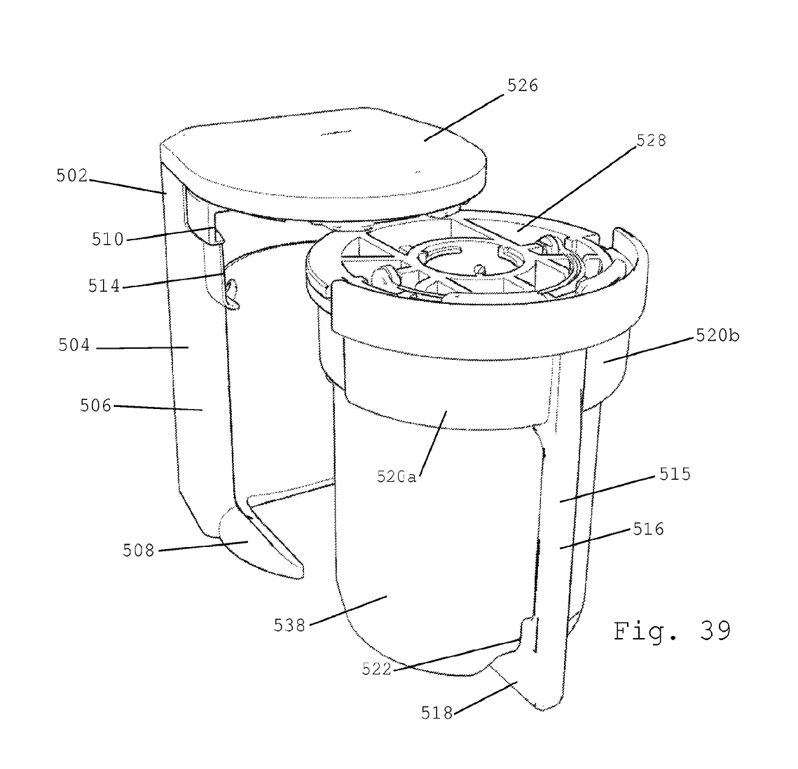

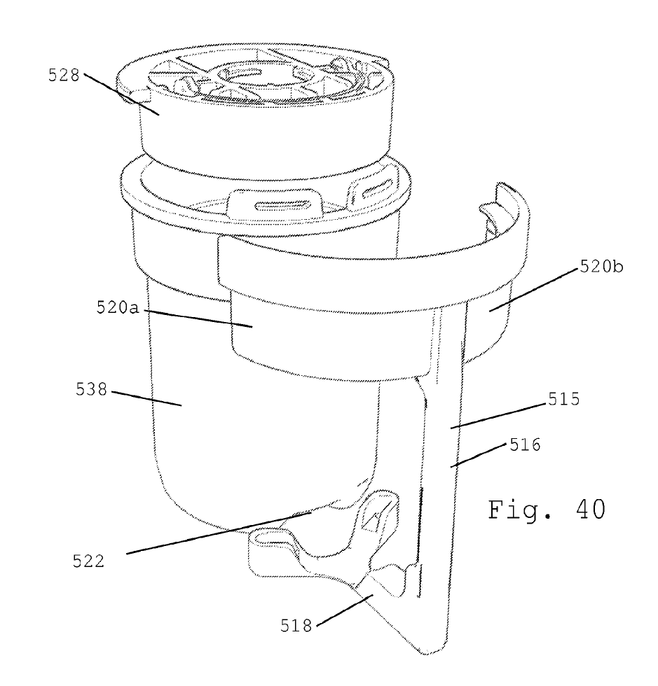

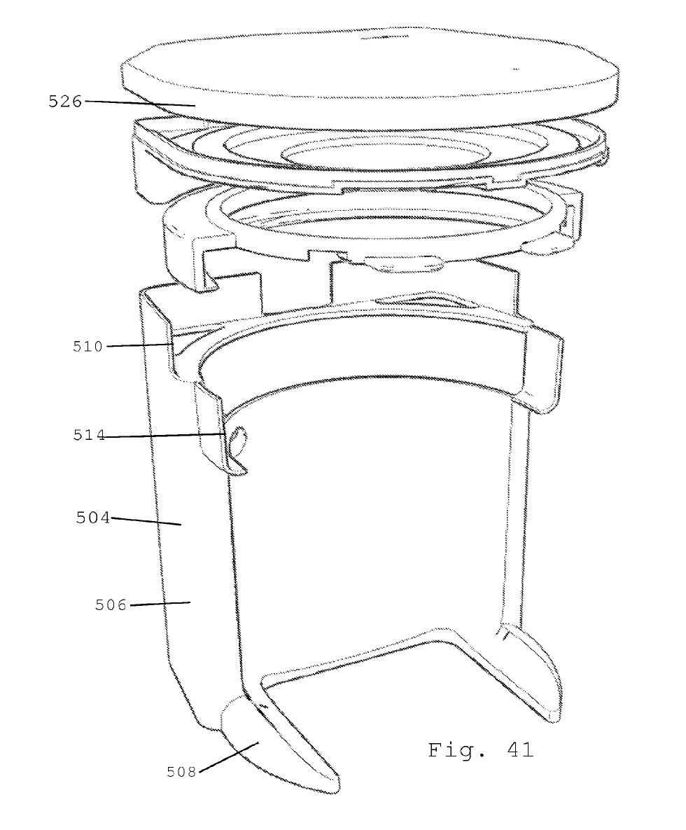

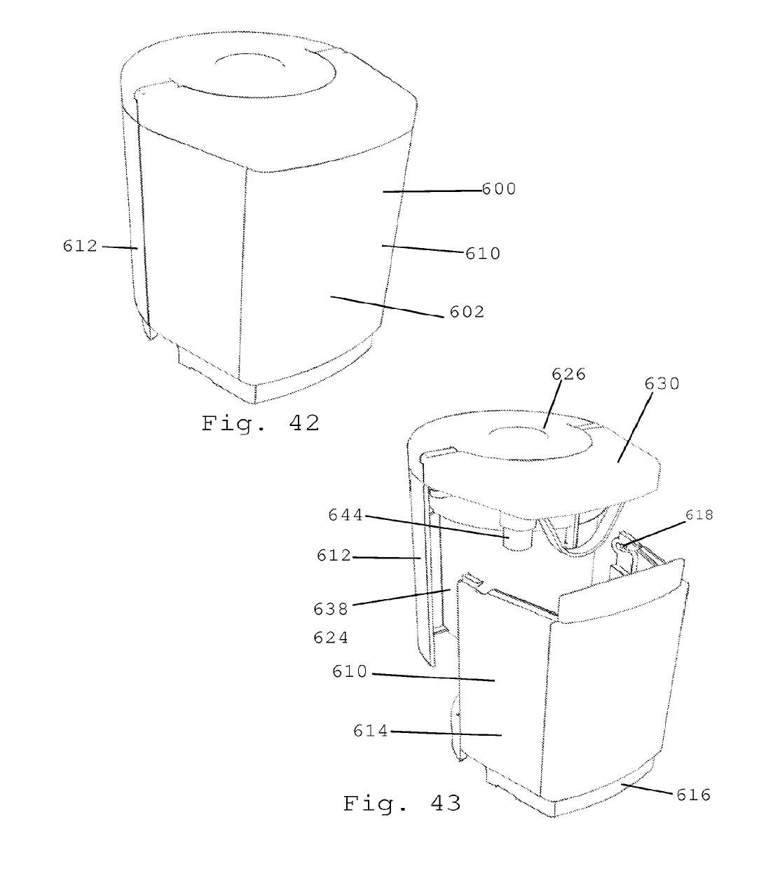

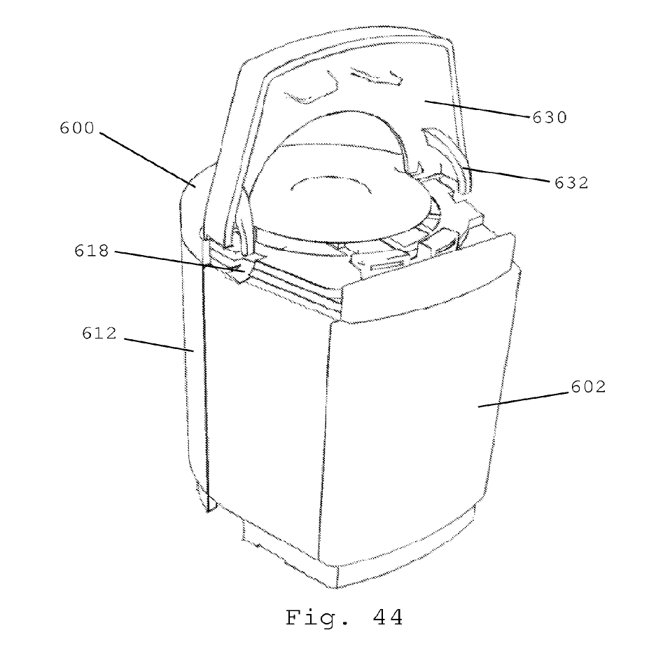

FIGS. 38-41 illustrate a variation on the second embodiment that is generally designated 500, wherein the back housing 224 is eliminated to enable easy removal of the pressure vessel 538. This variation is substantially similar to the second embodiment 200, therefore, the internal components will not be described again in detail. Suffice it to say that in this variation, the top lid 526, display 502, water mantle cover 528, pressure vessel 538, filter assembly (not shown) and disinfection system (not shown) are substantially the same as in the second embodiment 200. In this variation 500, however, the display 502 is integrally connected to a mounting stand 504 that includes a pair of sidewalls 506, a pair of feet 508, an upper slot 510 on the bottom of the top lid 526, and a lower slot 514 on the inner surface of the stand 502. In addition, the pressure vessel 538 interfits with a handle 515 for enabling easy removal of the pressure vessel 538 from the stand 504. In the illustrated embodiment, the handle 515 includes a vertical support member 516, a bottom member 518 extending at an angle from the vertical support member 516, and a pair of curved arms 520a-b that wrap around the sides of the pressure vessel 538. The bottom of the pressure vessel may include a cutout 522 shaped to receive the bottom member 518 such that the bottom member 518 and the arms 520a-b can snap-fit, or otherwise attach, to the pressure vessel 538. The pressure vessel 538 and handle 515 may be connected to the stand 502 by sliding the upper portion of the pressure vessel 538 and the water mantle cover 528 into the upper slot 510 and a second portion of the pressure vessel 538 and the arms 520a-b into the lower slot 514. In this variation, the water inlet and outlet (not shown) may be incorporated into the stand 504 in a similar manner to the incorporation of the inlet 242 and outlet 244 on the second embodiment.

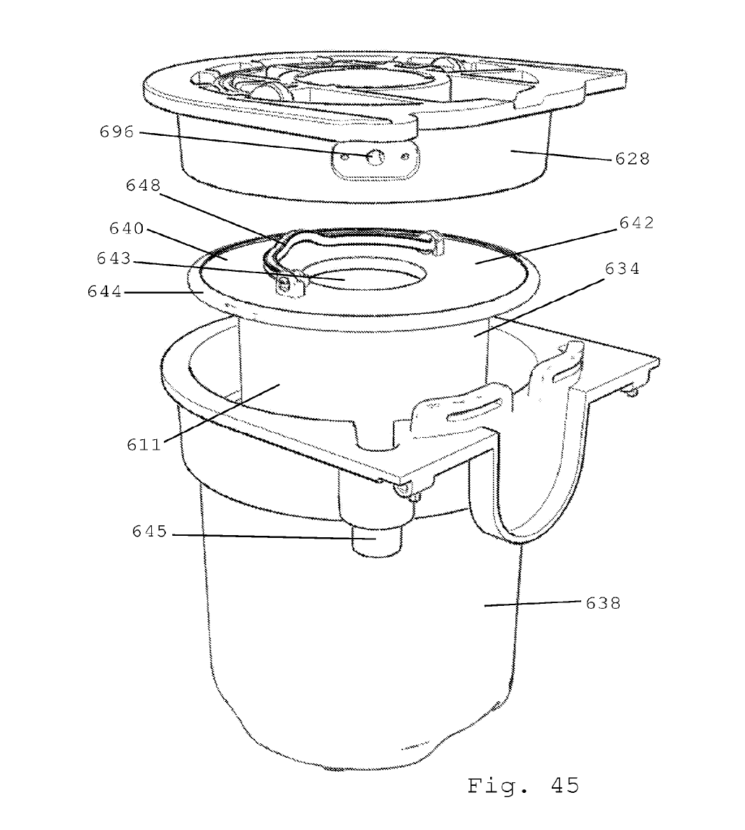

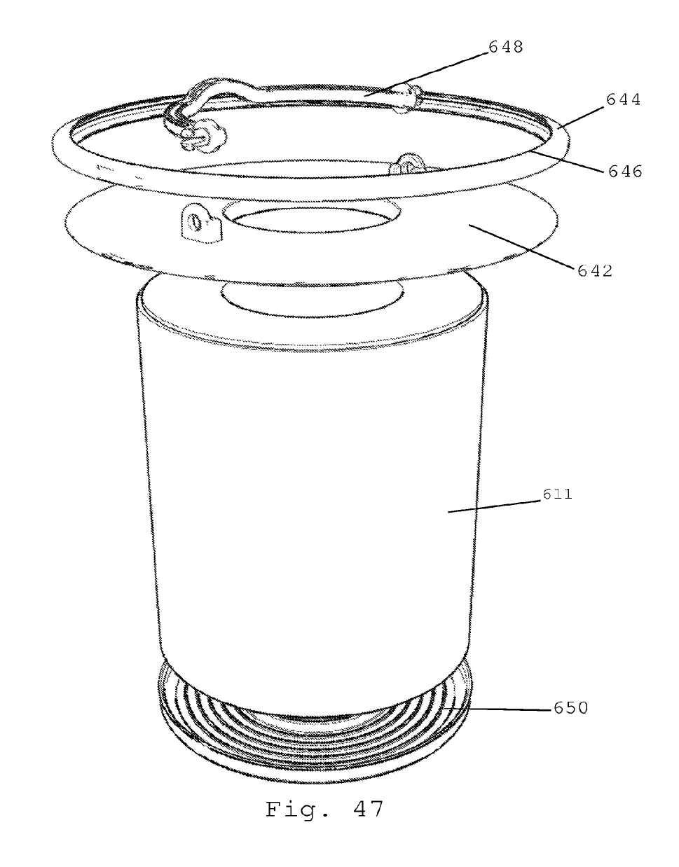

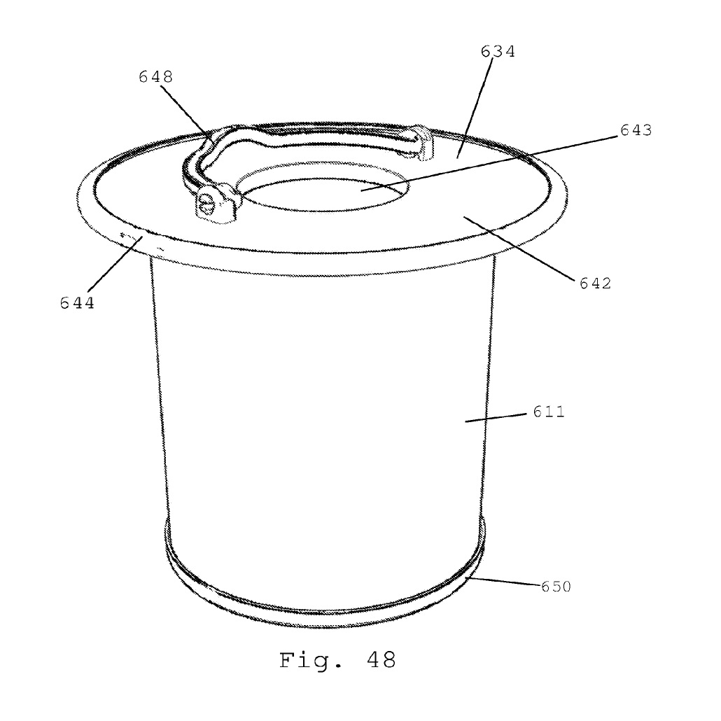

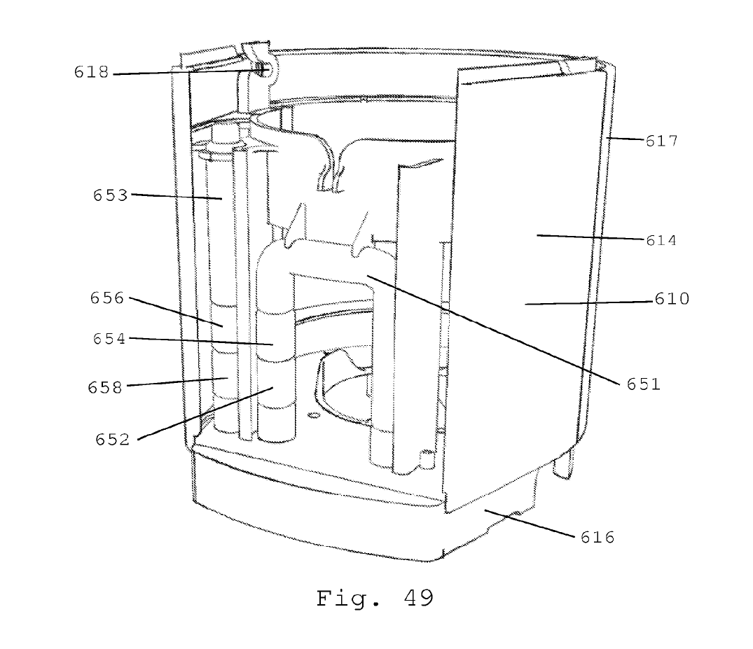

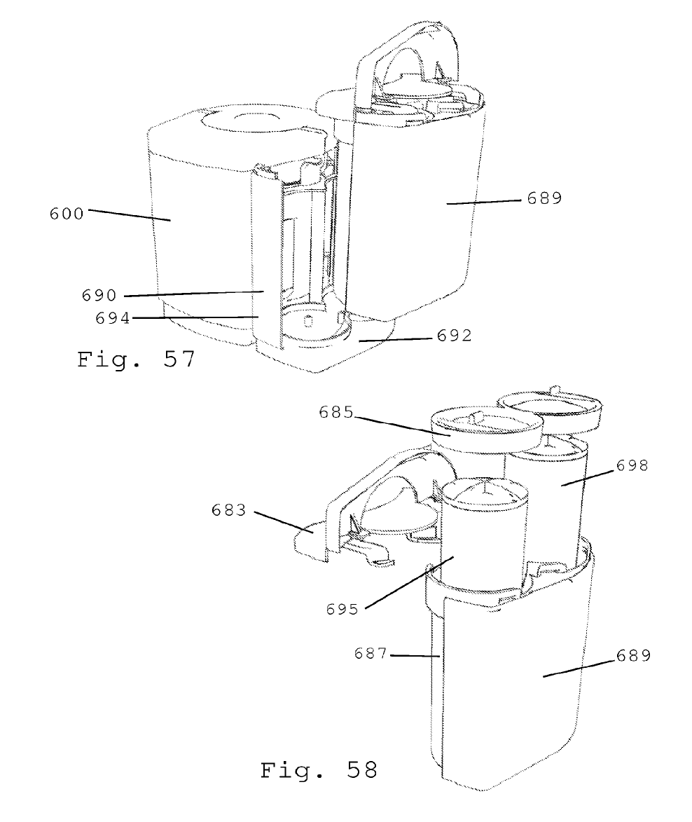

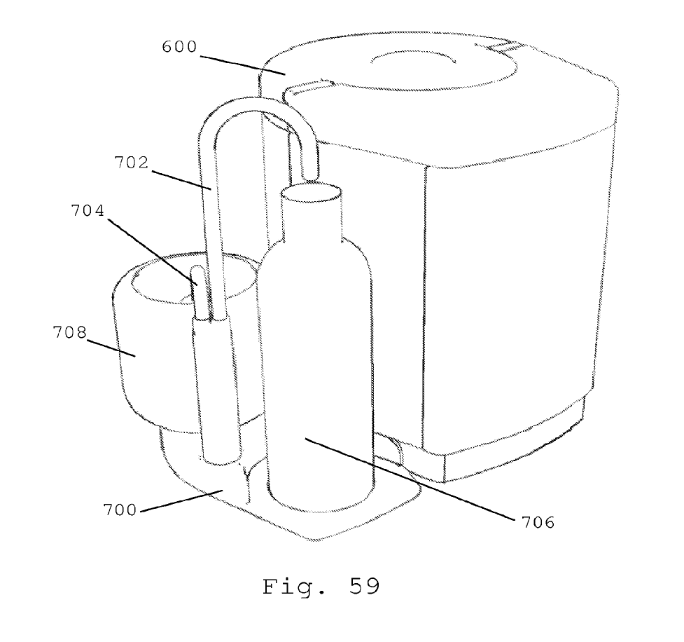

Another variation of the second embodiment is shown in FIGS. 42-59. This variation, generally designated 600, includes an electronics portion 610 that can be separated from a treatment portion 612. This components of this variation are substantially similar to the second embodiment 200, including the electronic display 602, the pressure vessel 638, the filter media 611 and the optional disinfection system (not shown).

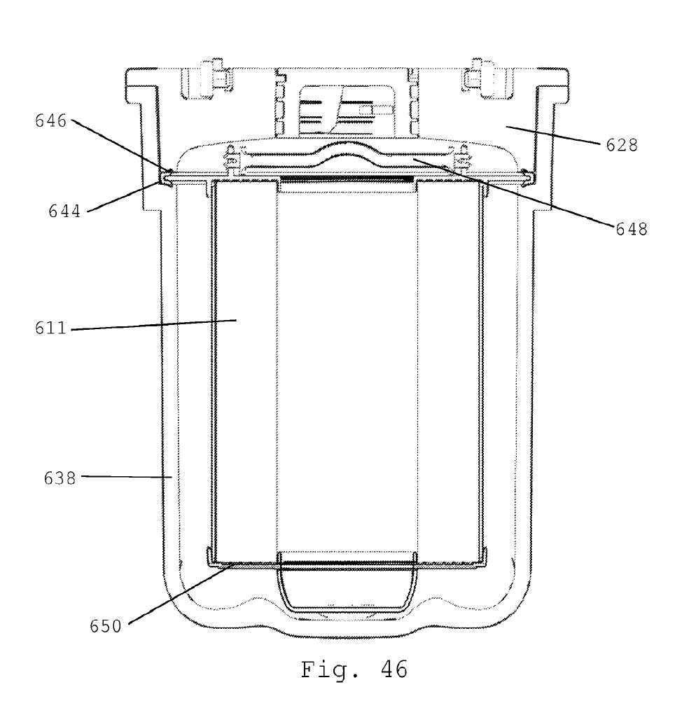

As shown in FIGS. 43 and 44, the electronics portion 610 includes the display 602, which is substantially similar to the electronics displays 202 and 47, and therefore will not be described in detail. A pair of sidewalls 614 and a base 616 are connected to the display 602. The sidewalls 614 may each include a groove 618 opening to the top of the sidewalls 614. The treatment portion 612 includes the rear housing 624, top lid 626, and the treatment components, including the pressure vessel 638, and the filtration and disinfection assemblies positioned within the pressure vessel 638. As shown, top lid 626 includes a pivoting portion 630 with a pair of hooks 632 that are inserted into the grooves 618 on the electronic portion to connect the two portions 610, 612. When the pivoting portion 630 is closed, as in FIG. 43, the system is latched shut. When the pivoting portion 630 is rotated up into the open position, as in FIG. 44, the pivoting portion 630 can be used as a handle to detach the treatment portion 612 from the electronics portion 610.

FIGS. 45-48 show an alternative arrangement for sealing the filtration assembly 634 within the WTS 600. The alternative filter seal will be described in connection with the WTS 600, however, it should be appreciated that the alternative filter seal could be used with all of the WTS embodiments, particularly the WTS 200. In the illustrated embodiment, the top cap 312 of the filtration assembly in the WTS 200 is replaced with an alternative top cap 640. The top cap 640 attaches to the upper end of the filter media 611, and includes a generally flat central portion 642 and a seal portion 644 extending around the perimeter of the central portion 642. The central portion 642 and seal portion 644 may be formed from different materials that are co-molded to each other, or otherwise attached to each other to form a single piece, or they may be formed from the same unitary piece of material, such as a flexible elastomer. In one embodiment, the central portion 642 is formed form a higher durometer material than the seal portion 644. The central portion 642 includes a cutout 643 for receiving a disinfection system in the same manner as the top cap 312 noted above. The top cap 640 may additionally include a handle 648 that pivotally attaches to the top of the top cap 640 to enable removal of the top cap 640. As shown in FIGS. 46-48, the sealing portion 644 may have a C-shaped cross section that flares outwardly at the inner edges 646. When inserted into the pressure vessel 638, the sealing portion 644 seals against the wall of the pressure vessel 638. The filtration assembly may also include a bottom cap 650, similar to the bottom end cap 324 described above, however, as a result of the top end cap 640 sealing against the sidewall of the pressure vessel 638, it is not necessary for the bottom cap to provide a seal against the bottom wall of the pressure vessel 638.

The water routing cover 628 is generally the same as the water routing cover 228 of the second embodiment, except that the positions of the water inlet port (not shown) and water outlet port 696 have been moved. In one embodiment, the water routing cover may now include a water inlet port, with the water inlet into the pressure vessel moved to the bottom of the pressure vessel 638. The water outlet 696 may be moved to the side of the water routing cover 628. Water exiting the WTS 600 through the outlet nozzle 645 on the pressure vessel 638 is therefore routed from the central opening 643 through the outlet port 696 and out of the outlet nozzle 645. The water entering the pressure vessel 638 through the inlet port enters into the space between the pressure vessel 638 and the filter media 611 (and possibly an optional prefilter), such that it can flow through the filter media 611, and then the optional disinfection system as described above in connection with the WTS 200.

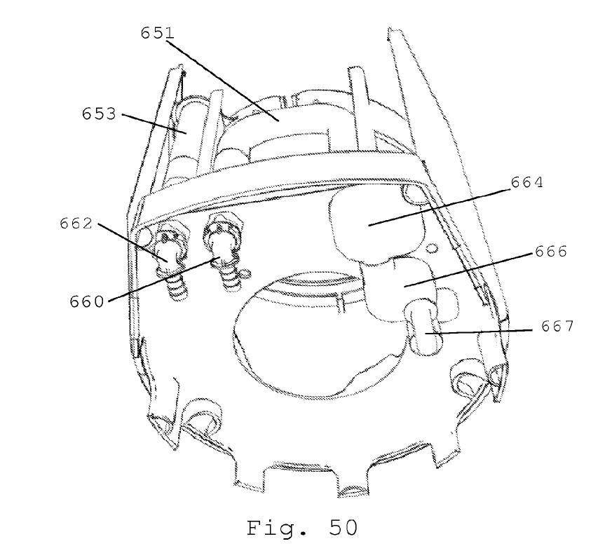

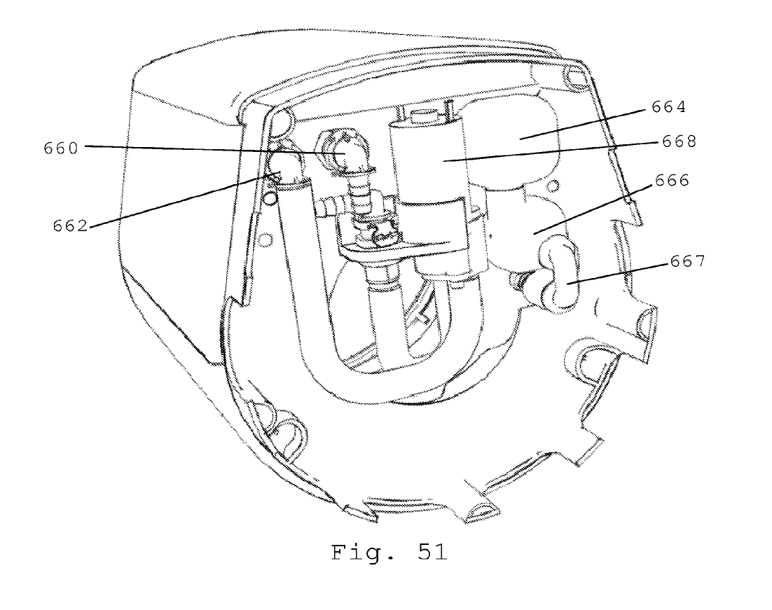

One embodiment of the electronics portion 610 is illustrated in FIG. 49 (with the display 602 removed, and an alternate rear panel 617 of the treatment portion connected to the sidewalls 614). As shown, the electronics portion 610 may include a plurality of sensors, such as a water temperature inlet sensor 652, a water pressure inlet sensor 654, a water pressure outlet sensor 656 and a water temperature outlet sensor 658. As shown in FIGS. 49 and 50, water entering the WTS 600 through the water inlet 660 flows through a sensor loop 651 including the inlet sensors 652, 654 before it is routed into the bottom of the pressure vessel 638. Treated water flowing from the pressure vessel 638 and through the outlet nozzle 645 flows into an outlet tube 653 and through the outlet sensors 656, 658 before exiting the system via the outlet 662. As noted above in connection with the WTS 200, each sensor may communicate with one or more electronic books on the electronic display 602, for instance, via RFID technology. The loop 651 and the outlet tube 653 are positioned to place the sensors in close proximity to the display 602 and any electronics bricks on the display 602 to facilitate such communication. In another embodiment, shown in FIG. 50, the WTS 600 (or any other WTS embodiment), includes one or more valves for controlling the flow of water into the system. As illustrated, the WTS includes an electronic control valve 664, and a manual control valve 666. The electronic valve 664 and the manual valve 666 may be connected to one or more modular switches that cause the valves 664 or 666 to shut off the water entering the system in response to a particular event, such as the separation of the treatment portion 604 from the electronics portion 602, the removal of a filter, or the failure of the disinfection system. The valves 664, 666 are capable of preventing the flow of water through the inlet elbow 667, which directs water into the pressure vessel 638. The system 600 may optionally include one of the valves 664, 666, or both. Another option is shown in FIG. 51. In this option, the WTS 600 includes a pressure assist mechanism, such as a conventional pump 668 connected to the water outlet 662 (or alternatively the inlet 660) to draw water through the WTS 600. The pressure assist pump 668 may be beneficial in situations where the water lines connected to the WTS do not have pressure (such as a tank of water connected to the WTS), or in situations where the water lines have less pressure than desired. In the illustrated embodiment, with the pump 668 mounted to the water outlet 662, the pump can be used to “pull” water through the WTS 600.

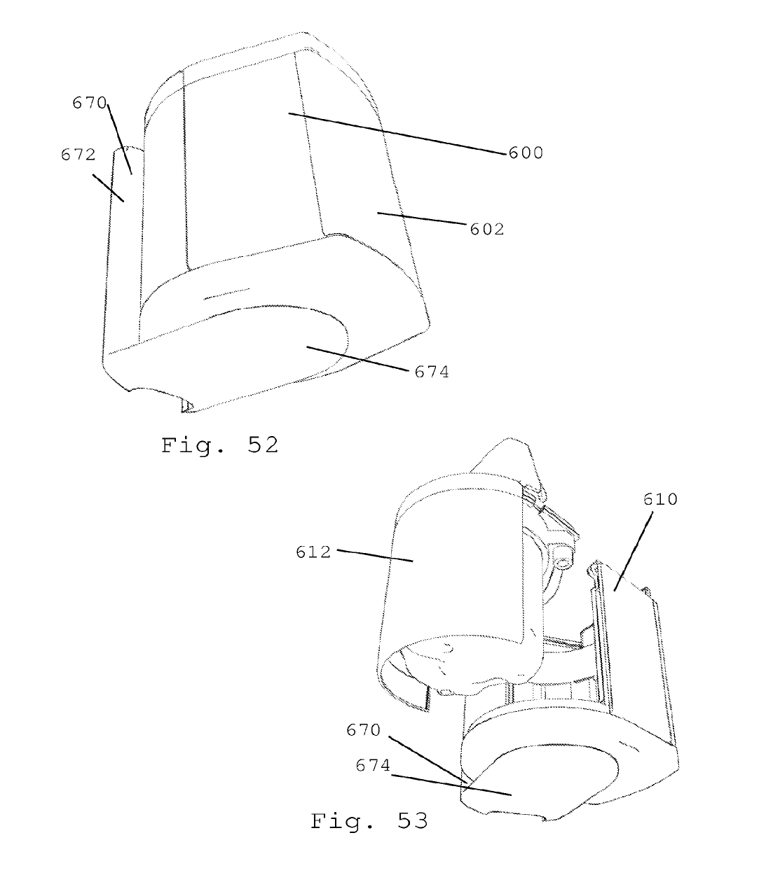

FIGS. 52-53 illustrate a swivel mount base 670 for the WTS 600 (or any other WTS embodiment). In the illustrated embodiment, the swivel mount base includes a vertical panel 672 configured to be mounted to a vertical surface, such as a wall, and a horizontal panel 674 extending from the vertical panel for supporting the WTS 600. As shown in FIGS. 53-53, the base 616 of the WTS 600 may be mounted to the swivel mount base 670 in such a way that it can be rotated between a first position (shown in FIG. 52) in which the display 602 is visible, and a second position (shown in FIG. 53) in which the treatment portion 604 can be removed from the electronics portion 602 by lifting the handle 630 to release the treatment portion 604.

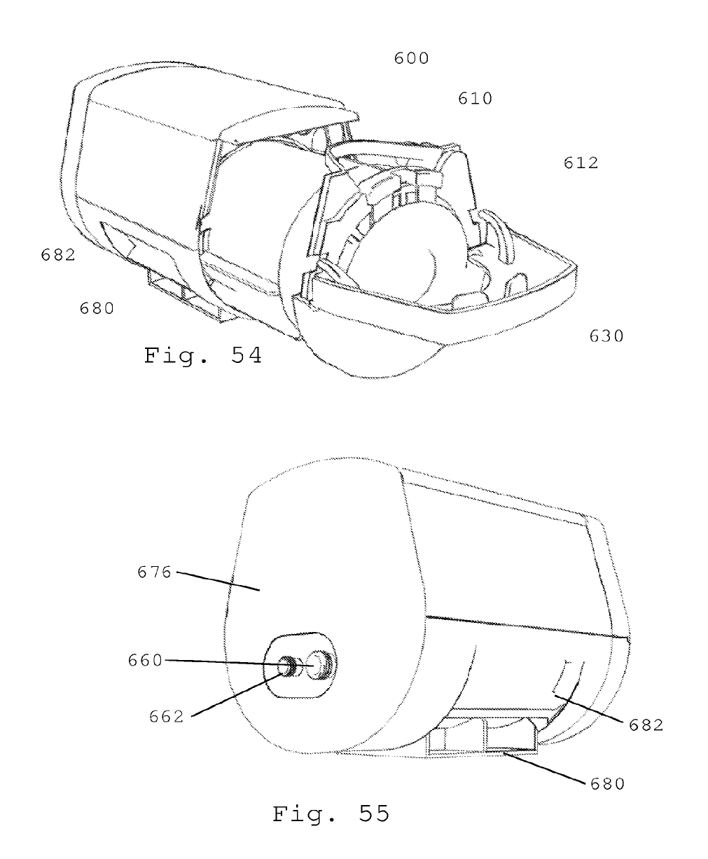

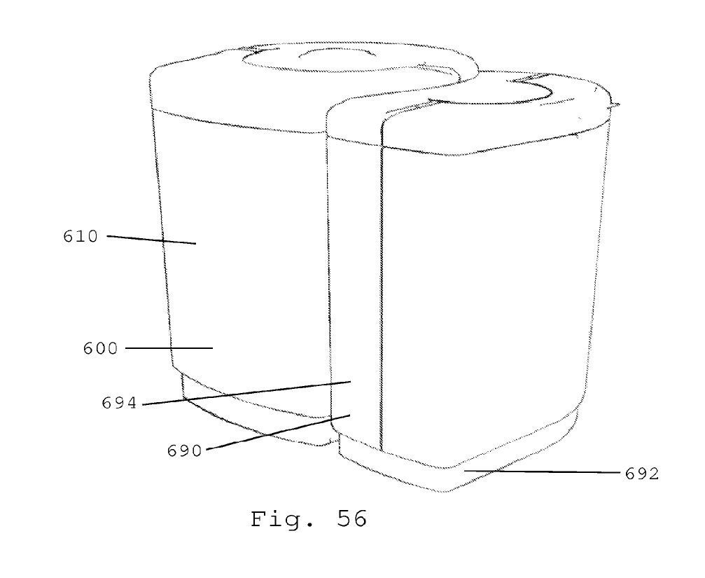

FIGS. 54-55 illustrate another variation of the WTS 600, wherein the system is configured to be mounted horizontally. In this variation, the WTS 600 includes a wall mount bracket 680 extending from a rear wall 682 that is connected to the electronics portion 610 and forms a housing for the treatment portion 612. As shown in FIG. 54, the treatment portion 612 may be longitudinally removed from the electronics portion by pulling the pivoting handle 630 to slide the treatment portion 612 out from the electronics portion 610. As shown in FIG. 55, the water inlet 660 and outlet 662 may be covered with a dome shaped cover 676 to create an aesthetic appearance for the bottom side of the WTS 600.

FIGS. 56-59 show a further variation of the WTS 600 including a secondary filter housing 690. In one embodiment, the secondary filter housing 690 includes a front portion 689, a secondary base 692 and a sidewall 694 extending from the electronics portion 610. The secondary filter housing 690 may be configured to contain one or more filters 695, 698 that contain filter media for the treatment of specific contaminants. For instance, the filters 695, 698 may specifically treat arsenic or hardness, or nitrates, or may add back ingredients to the water, such as fluoride. As shown, the secondary filter housing 690 is configured to receive two filters 695, 698 in separate cartridges 687 located in the front portion 689 of the housing 690. The cartridges may each include a top cap 685 for closing each cartridge 687, and a closure 683 may fit over the top caps 685 to connect the front portion 689 to the sidewall 694. In another embodiment, a single filter, or additional filters may be used as desired. The secondary filters 695, 698 are connected to the main filter 611, such that water flowing through secondary filters 695, 698 also flows through the main filter 611. In one embodiment, the secondary filters are arranged in parallel with each other, such that water flowing through the main filter 611 can be routed through either the first secondary filter 695 or the second secondary filter 698. In another embodiment, the secondary filters are arranged in series, such that water flowing through the main filter 611 flows through both the first secondary filter 695 and the second secondary filter 698. The secondary filter housing 690 may be positioned on either side of the WTS 600, such that it is connected to the water outlet 662 downstream from the main filter 611, which is particularly advantageous in situations where it is desirable to add ingredients to the treated water, such as fluoride, or carbonation. Alternatively, the secondary filter housing 690 may be connected to the inlet elbow 667, or another component positioned upstream from the main filter 611, which may be advantageous in removing contaminates from the water before they enter the main filter 611. In yet another embodiment, secondary filters may be positioned on both sides of the main WTS 600 (adding both upstream and downstream filters). FIG. 59 shows a variation of the WTS 600 including a dispensing system 700 connected to the outlet 662 of the WTS 600. In this embodiment, the dispensing system 700 includes a dispensing nozzle 702. The dispending nozzle 702 is configured to dispense into a water bottle 706. The dispense tubing 704 can be coiled to rest in tubing container 708. The dispensing nozzle 702 may be removed from its resting base, extending the dispense tubing 704 out of the tubing container 708 to dispense into objects within tubing reach without having to move the entire main WTS 600. Of course, various other dispenser styles may be included. In another embodiment, the outlet of the WTS 600 (or any other WTS embodiment) may be configured to attach to a specific downstream device, such as a dishwasher, drinking fountain, or soda machine.

### III. Third Embodiment

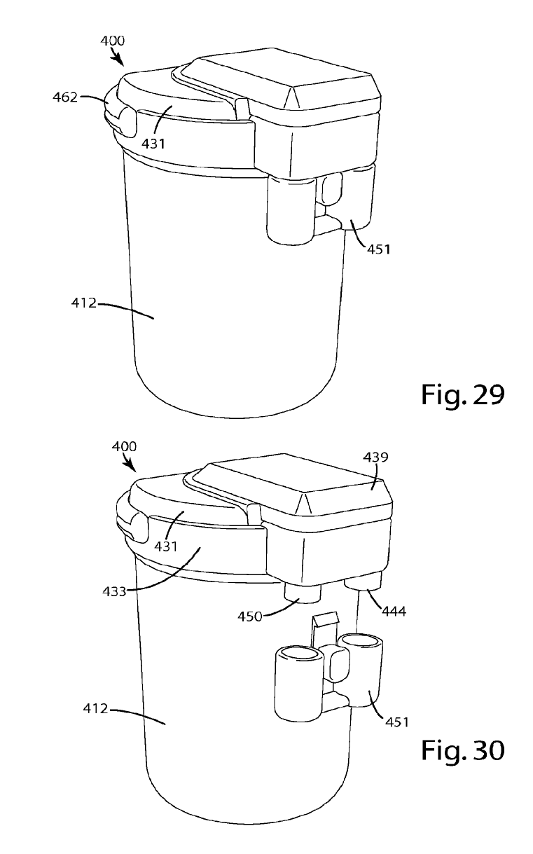

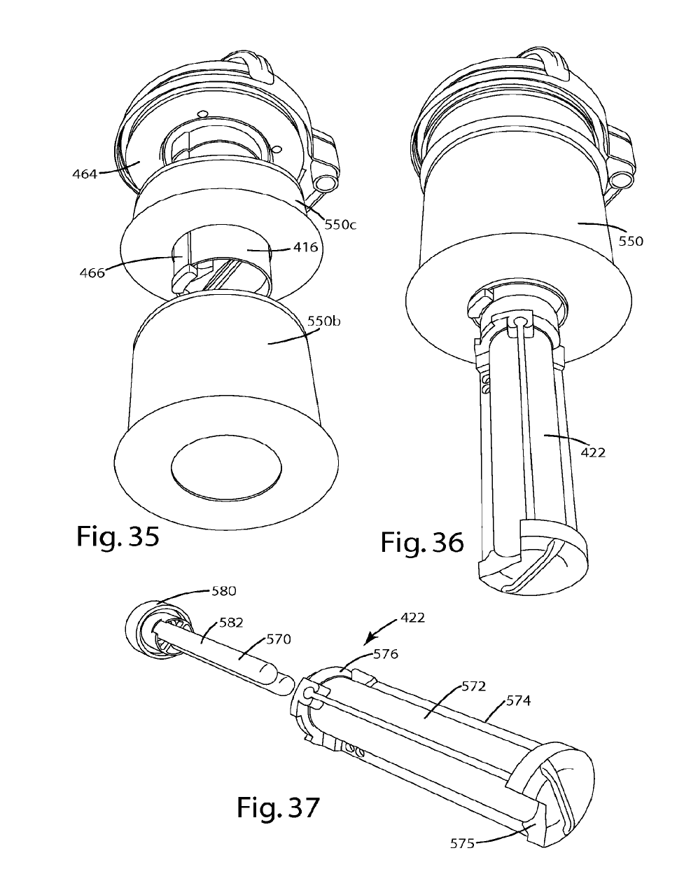

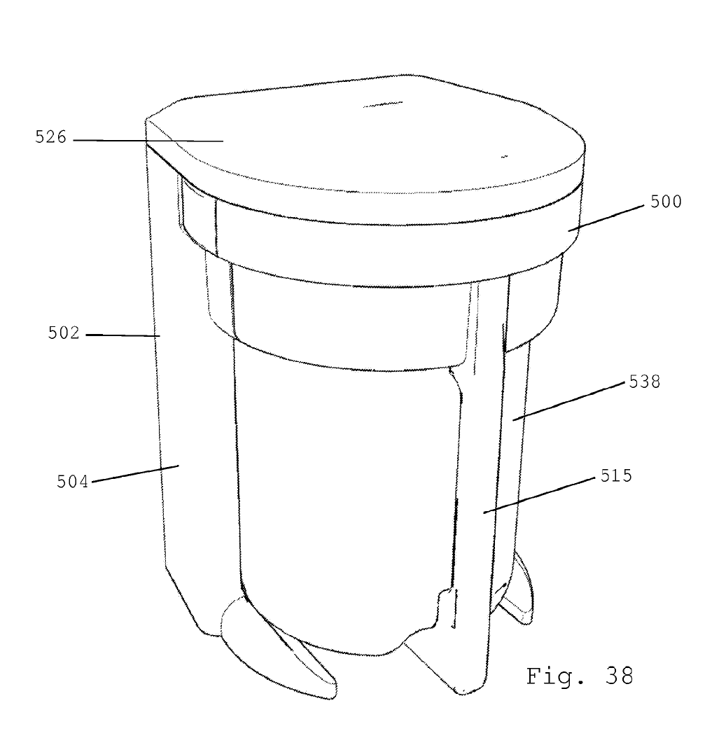

A WTS according to a third embodiment of the present invention is shown in FIGS. 27-37 and generally designated 400.

The embodiment illustrated in FIGS. 27-37 provides a water treatment system that accommodates one or more easily removable and interchangeable filter modules 550. This embodiment allows a manufacturer or consumers to customize the filtration components of a WTS to meet the needs of a particular application. As shown in FIG. 27-31, the WTS 400 includes a pressure vessel 412, a water routing mantle 414, a center baffle 416, a filter assembly 420 and an optional disinfection assembly 422. In one embodiment, the pressure vessel 412 is a generally cylindrical container with a sidewall 424 including a top edge 426 that defines an opening 428. The sidewall 424 includes an outwardly extending groove 430 near the top edge 426.

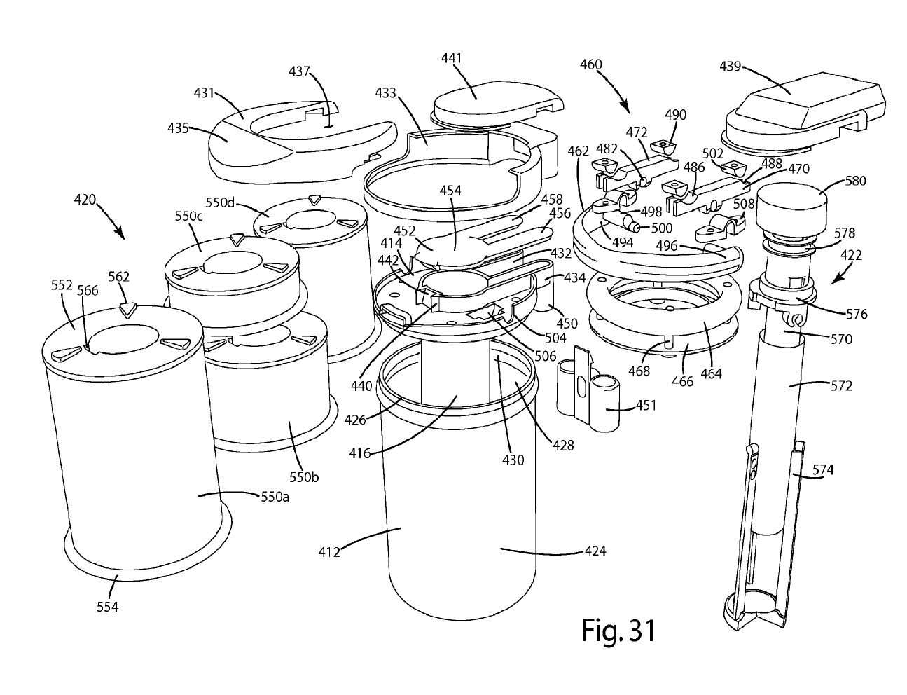

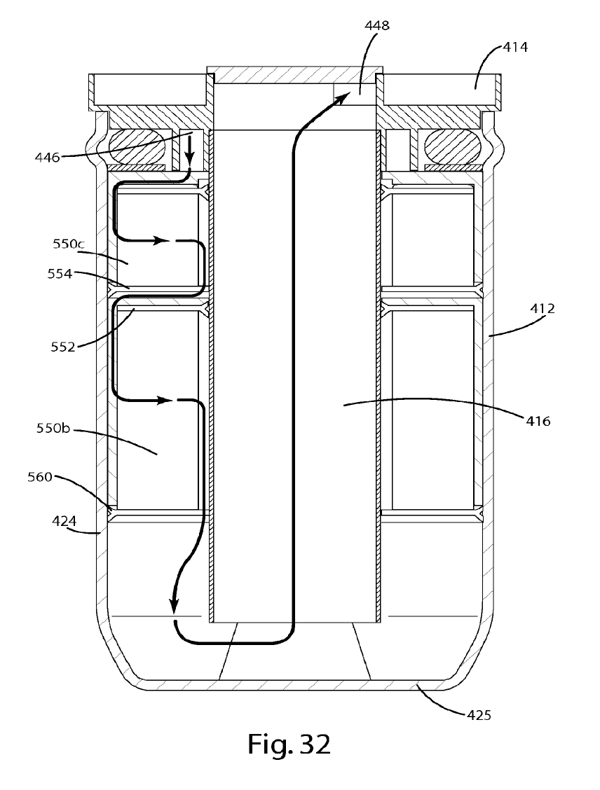

The water routing mantle 414 of the WTS 400 is generally circular in shape and sized to fit inside the opening 428 of the pressure vessel 412. As shown in FIGS. 31 and 32, the center baffle 416 may be attached to the water routing mantle 414. In addition, the center baffle 416 may include an outwardly extending protrusion 440 extending the length of the center baffle 416, and an inwardly extending protrusion 442 extending at least along the top portion of the center baffle 416 above the water routing mantle 414. The water routing mantle 414 additionally includes an integrally formed water inlet tube 432 and water outlet tube 434. The water inlet tube 432 includes an entrance 444, shown in FIG. 30, at the back of the WTS 400, and an exit 446 (shown in FIG. 32) extending into the pressure vessel 412 outside of the center baffle 416 to route untreated water into the first filter assembly 420. The water outlet tube 434 includes an entrance 448 (shown in FIG. 32) within the center baffle 416 and an exit 450 at the back of the WTS 400 to route treated water from the inside of the center baffle 416 to the outside of the WTS 400. A tube connector 451 may be attached to the entrance 444 of the inlet tube and to the exit 450 of the outlet tube at the back of the WTS 400 to enable connection to a desired tube or connector. A mantle top 452 includes a first portion 454 that closes and seals the top opening of the center baffle 416, a second portion 456 that extends over the top of the water routing tube 434, and a third portion 458 that extends over the top of the water routing tube 432.

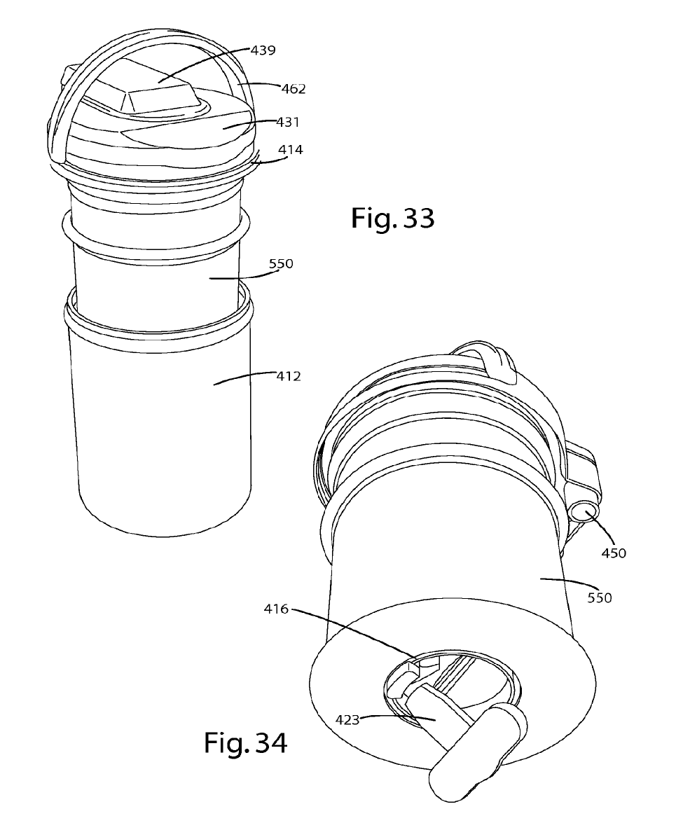

A handle assembly 460 attaches to the water routing mantle 414. The handle assembly includes a handle 462 that is movable between a closed position, shown in FIG. 31 wherein the handle assembly 460 seals the mantle 414 to the pressure vessel 412, and an open, upright position, shown in FIG. 33, wherein the seal is released to enable removal of the water routing mantle 414. Referring to FIG. 31, in one embodiment, the handle assembly 460 includes a compressible sealing ring 464 formed of a resilient material such as silicone rubber, rubber, a compressible thermoplastic, or the like. The sealing ring 464 is positioned to align with the groove 430 in the pressure vessel 412 when the mantle 414 is attached to the vessel 412. A ring-shaped seal plate 466 is positioned below the sealing ring 464, and four rods 468 extend upwardly from the seal plate 466 and through spaced apart holes in the sealing ring 464. Two of the rods 468 extend through holes in a first yoke 470 and two of the rods extend through holes in a second yoke 472. Each yoke 470, 472 includes a lower surface including a U-shaped groove 482 and an upper surface including a pair of arcuate recesses 486, 488. The rods 468 extend through holes positioned within the recesses 486, 488 and into four corresponding nuts 490 positioned within the recesses 486, 488. Each of the nuts 490 has a rounded lower surface 502 that engages the arcuate recess 486 or 488. The handle 462 includes ends 494, 496 that each include a first inwardly extending protrusion 498, and a second protrusion 500 extending inwardly form the first protrusion 498. The second protrusion 500 is offset from the center of the first protrusion 498.

The handle assembly 460 connects to the water routing mantle 414 with the handle 462 positioned on the top surface 520 of the mantle 414. The first protrusions 498 on the handle ends 494, 496 extend through cutouts 504 in the mantle 414, and the second protrusions fit into recesses 506 within the upper surface 520 of the mantle 414. A pair of clamps 508 attach over the first protrusions 498 to hold the handle 462 in place on the mantle 414. The yokes 470, 472 are interfitted over the mantle 414 with the U-shaped groove 482 of each yoke interfitted over one of the second protrusions 500. The sealing ring 464 and seal plate 466 are positioned below the mantle 414, and the rods 468 extend upwardly from the seal plate 466 through the sealing ring 464, the holes 510 in the mantle 414, the yokes 470, 472, and into the nuts 490. In operation, rotation of the handle 462 causes the offset protrusions 500 to function as cams, such that as the handle 462 is moved to the closed position, the rounded surfaces 502 of the nuts 490 are caused to travel upward along the arcuate recesses 486, 488, drawing the rods 468 and the seal plate 466 towards the mantle 414, thereby compressing the sealing ring 464. As the sealing ring 464 is compressed, it expands to fill the groove 430 in the pressure vessel 412 to seal the mantle 414 to the pressure vessel 412. In the illustrated embodiment, the protrusions 500 on the handle 462 are offset to a position that causes the seal 464 to remain compressed until the handle 462 is opened to the open position at an angle of about 90 degrees.

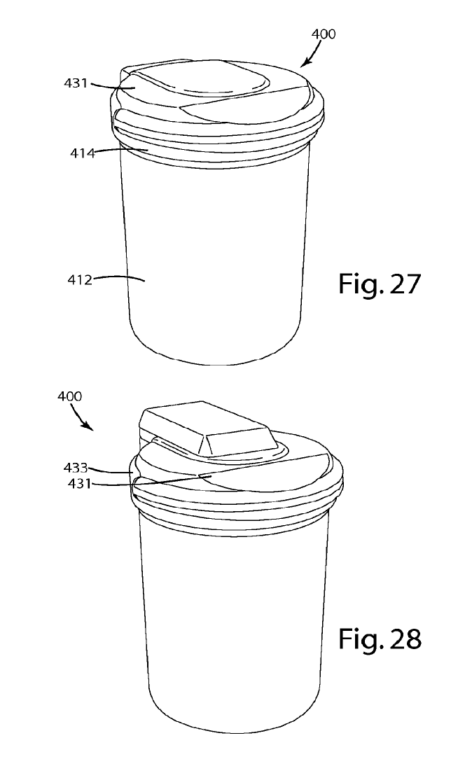

As shown in FIGS. 28 and 31, the WTS 400 includes a display cover 431 and a dress collar 433 attached to the water routing mantle 414. The dress collar attaches to the upper surface of the water routing mantle 414, and the display cover 431 is sized to interfit with the dress collar 433, for instance, by snap fitting to the dress collar 433 or by threads or another fastening method. The display cover 431 may accommodate a wide variety of displays, such as an LCD display or another conventional display on the display surface 435 of the display cover 431 for displaying a variety of characteristics about the WTS 400, such as filter status, power status, and water quality. In one embodiment, the display cover includes a slot 437 for receiving an electronics module 441. The electronics module 441 may include a variety of electronic components that may be utilized by the WTS 400, such as power supplies, sensors, controllers and associated circuitry. In one embodiment, as discussed above, the WTS 400 may utilize an inductively coupled ballast circuit, such as that disclosed in U.S. Pat. No. 6,825,620 to power one or more components, including a UV lamp for a UV disinfection module. The ballast circuit—including a primary coil—may be housed in another electronics module 439. In the embodiment shown in FIGS. 28-31, the electronics module 439 extends above the top of the display cover 431, and the electronics module may include its own display for displaying the status of the UV module 422. In another embodiment, shown in FIGS. 27 and 31, wherein the WTS 400 does not include a disinfection module 422 another electronics module 441, may be substituted for the electronics module 439.

In the illustrated embodiment, the primary filter assembly 420 is comprised of one or more cylindrical filter blocks 550a-d. As shown in FIG. 31, the filter blocks are provided in a variety of heights, such that multiple filter blocks can be stacked on top of each other within the pressure vessel 412. In this way, a manufacturer or a consumer can insert one or more filter blocks 550a-d into the pressure vessel 412 to customize the water filtration to meet a specific application. In one embodiment, a single filter block 550a, having about the same height as the pressure vessel 412 could be used. In another embodiment, a plurality of shorter filter blocks 550b, 550c and 550d could be stacked together.

The filter blocks 550a-d are configured to route water entering the pressure vessel 412 through each of the filter blocks 550a-d, and then into the interior of the center baffle 416, where a disinfection module may be positioned. As shown in FIGS. 31 and 32, each filter block 550 includes an upper end cap 552 and a lower end cap 554. The end caps 552, 554 are configured to control the water path through the filters. More particularly, the end caps 552, 554 are configured so that the top end cap 552 of each filter block 550 seals against the center baffle 416, and the bottom end cap 554 of each filter block 550 seals against the sidewall 424. As shown in FIG. 32, portions of each end cap 552, 554 may include sealing flaps 560, or another sealing mechanism. The filter blocks 550 may each additionally include one or more protrusions 562 extending upwardly from the top end cap 552 to provide a space for water to flow between the stacked filter blocks 550. In the illustrated embodiment, the top end cap 552 of each filter block includes three protrusions 562 that are approximately evenly spaced about the end cap 552. The filter blocks 550 may be oriented with respect to each other by aligning a notch 566 in the inside of each end cap 552, 554 with the protrusions 440 on the exterior of the center baffle 416. In addition, as shown in FIG. 34, the filter assembly 420 includes a clip 423 that connects to the bottom of the center baffle 416 to retain all of the filter blocks 550 on the center baffle 416. In this way, the filter blocks 550 can be removed simply by removing the water routing mantle 414.

In one embodiment, one or more of the filter blocks 550 is a cylindrical carbon block filter assembly, such as the carbon block filter disclosed in U.S. Pat. No. 6,368,504 to Kuennen, wherein the carbon block includes activated carbon particles and a binder, and the carbon particles have a mean particle diameter ranging from about 60 microns to about 80 microns and wherein the carbon particles have a particle size distribution in which no more than about 10% by weight of the carbon particles are larger than about 140 mesh and no more than about 10% by weight of the carbon particles are smaller than about 500 mesh. Alternatively, each of the filter blocks 550 could be provided with a different carbon mixture. In yet another alternative, one or more of the filter blocks 550 could be a paper filter, such as a pleated paper filter, or a pleated woven filter, or a resin bead material, or another type of filter media, such as a hollow fiber membrane filter, or a filter directed to filtering out a specific type of contaminant. In one embodiment, one of the filter blocks 550 is a pleated paper prefilter, which is stacked on top of a second filter block 550 that is a carbon block filter. In one embodiment, the WTS 400 may be provided only with a filter assembly 420, and no disinfection assembly 422.

In the illustrated embodiment, the optional disinfection assembly 422 is an ultraviolet (UV) reactor, and functions substantially the same as the UV reactor described above in connection with the first and second embodiments, and will not be described again in detail. As illustrated in FIGS. 31, 36 and 37, the UV reactor 422 includes a UV lamp 570, a quartz tube 572, a UV reactor baffles 574, a baffle seat 576, secondary electronics 578, and a UV lamp cover 580.

The UV lamp 570 includes two side-by-side emitting bulbs 582 that are electrically connected to the secondary electronics—including a secondary coil—so that the bulb can be inductively powered via the electrical connection between the primary, located within the electronics module 439 positioned above the UV lamp, and the secondary 578. The UV reactor components fit within the interior opening of the center baffle 416, such that the center baffle 416 forms a UV reactor housing. In one embodiment, the bottom of the baffle 574 includes a cutout 575 to allow water flow into the UV reactor. In one embodiment, the UV reactor components 422 are held in place by the clip 423 on the center baffle 416, and can be removed as shown in FIG. 34 by pulling the UV reactor components through the bottom of the center baffle 416. As noted above, a wide variety of alternative disinfection modules, including other UV reactor configurations, may be used in place of the described UV reactor.

As in the first two embodiments, the filter assembly 420 and the disinfection assembly 422 may each include an information tag attached to or fitted within the assembly, which, as noted above, are used to store information about the particular filter or assembly in use, and to record parameters related to such use. Sensors within the electronics module 439 and module 441 inductively power and communicate with the information tags to obtain details regarding the stored information and parameters recorded.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A water treatment system comprising:
a first portion comprising a first flow path and a second flow path;
a second portion releasably coupled to said first portion, said second portion including an electronic component and a vessel having an inlet in fluid communication with said first flow path and an outlet in fluid communication with said second flow path; and
a treatment assembly within said vessel, said treatment assembly capable of receiving water from said vessel inlet, treating the water to remove contaminants, and guiding the treated water to the vessel outlet.

2. The water treatment system of claim 1 further including a first sensor in fluid communication with said first flow path for measuring a characteristic of the water flowing through said first flow path

3. The water treatment system of claim 1 further including a second sensor in fluid communication with said second flow path for measuring a characteristic of the water flowing through said second flow path.

4. The water treatment system of claim 1 further including a shut-off valve capable of being closed to prevent water from flowing into said vessel.

5. The water treatment system of claim 4 wherein said shut-off valve is connected to a switch, said switch actuating said valve to close said valve upon removal of said second portion from said first portion

6. The water treatment system of claim 4 wherein said shut-off valve is connected to a switch, said switch actuating said valve to close said valve upon failure of the disinfection system.

7. The water treatment system of claim 4 wherein the shut-off valve is positioned along the first flow path.

8. The water treatment system of claim 1 further including a pump positioned along said second flow path, said pump operable to draw water from said outlet.

9. The water treatment system of claim 1 further including a secondary treatment assembly configured to remove contaminants from water received from the first flow path before the water enters the vessel inlet.

10. The water treatment system of claim 1 further including a secondary treatment assembly configured to remove contaminants from water received from the vessel outlet before the water enters the second flow path.

11. The water treatment system of claim 1 further including a secondary treatment assembly configured to add an ingredient to water received from the vessel outlet before the water enters the second flow path.

12. The water treatment system of claim 1 further including an electronic display.

13. The water treatment system of claim 12 wherein the vessel of the second portion is coupled to the electronic display.

14. The water treatment system of claim 12 wherein the electronic display is rotatable.

15. The water treatment system of claim 1 wherein the treatment assembly comprises a filter media disposed between a first end cap and a second end cap.

16. The water treatment system of claim 15 wherein the first end cap and the second end cap are comprised of resilient material.

17. The water treatment system of claim 16 wherein the first end cap is configured to form a first seal at a first end of the treatment assembly when the treatment assembly is enclosed within the vessel.

18. The water treatment system of claim 17 wherein the first end cap is a top cap of the treatment assembly.

19. The water treatment system of claim 17 wherein the second end cap is configured to form a second seal when the treatment assembly is enclosed within the vessel, the second seal being at a second end of the treatment assembly opposite the first end of the treatment assembly.

20. The water treatment system of claim 1 wherein the treatment assembly comprises an ultraviolet lamp.

21. The water treatment system of claim 20 wherein the electronic component comprises power supply circuitry configured to provide power to the ultraviolet lamp.

22. The water treatment system of claim 21 wherein the power supply circuitry is configured to provide power to the ultraviolet lamp inductively.

23. A treatment system capable of being releasably coupled to a base, the base having a first flow path for providing untreated water to the treatment system and a second flow path for receiving treated water from the treatment system, the treatment system comprising:
a vessel having an inlet in fluid communication with the first flow path and an outlet in fluid communication with the second flow path, said inlet of said vessel being removably coupled to the first flow path, said outlet of said vessel being removably coupled to the second flow path;
a treatment assembly disposed within said vessel, said treatment assembly capable of receiving untreated water from said inlet of said vessel, treating water received by said inlet to remove contaminants, and guiding treated water to the vessel outlet; and
an electronic component configured to receive power from the base.

24. The treatment system of claim 23 wherein said inlet of said vessel is in fluid communication with a first sensor for measuring a characteristic of untreated water.

25. The treatment system of claim 23 wherein said outlet of said vessel is in fluid communication with a second sensor for measuring a characteristic of treated water.

26. The treatment system of claim 23 further including a secondary treatment assembly configured to remove contaminants from water received from the first flow path before the water enters said inlet of said vessel.

27. The treatment system of claim 23 further including a secondary treatment assembly configured to remove contaminants from water received from said outlet of said vessel before the water enters the second flow path.

28. The treatment system of claim 23 further including a secondary treatment assembly configured to add an ingredient to water received from said outlet of said vessel before the water enters the second flow path.

29. The treatment system of claim 28 further including said vessel being coupled to an electronic display.

30. The treatment system of claim 29 wherein the electronic display is rotatable.

31. The treatment system of claim 23 wherein the treatment assembly comprises a filter media disposed between a first end cap and a second end cap.

32. The treatment system of claim 31 wherein the first end cap and the second end cap are comprised of resilient material.

33. The treatment system of claim 32 wherein the first end cap is configured to form a first seal at a first end of the treatment assembly when the treatment assembly is enclosed within the vessel.

34. The treatment system of claim 33 wherein the second end cap is configured to form a second seal when the treatment assembly is enclosed within the vessel, the second seal being at a second end of the treatment assembly opposite the first end of the treatment assembly.

35. The treatment system of claim 34 wherein the treatment assembly comprises an ultraviolet lamp.

36. The treatment system of claim 35 wherein the electronic component comprises power supply circuitry configured to provide power to the ultraviolet lamp.

37. The treatment system of claim 36 wherein the power supply circuitry is configured to provide power to the ultraviolet lamp inductively.
